(19) United States
(12) Patent Application Publication
(10) Pub. No.: US 2026/0279689 A1
(43) Pub. Date: Sep. 17, 2026

(54) FABRICATION OF CAPACITORS

(71) Applicant: PACESETTER, INC., Sylmar, CA (US)

(72) Inventors: Ralph Jason Hemphill, Sunset, SC (US); David Bowen, Taylors, SC (US); Xiaofei Jiang, Clemson, SC (US); Nicholas Hamor, Easley, SC (US); Ronald Wilson, Easley, SC (US); Peter Fernstrom, Pickens, SC (US); John Duggan, Greenville, SC (US); Justin King, Liberty, SC (US)

(21) Appl. No.: 19/165,118

(22) PCT Filed: Mar. 3, 2024
(86) PCT No.: PCT/US24/18274

§ 371 Date: Sep. 13, 2025

Related U.S. Application Data
(60) Provisional application No. 63/452,157, filed on Mar. 14, 2023.

(51) Int. Cl. H01G 9/042; H01G 9/00; H01G 9/008; H01G 9/048; H01G 9/06

(52) U.S. Cl. CPC H01G 9/0425; H01G 9/0029; H01G 9/008; H01G 9/048; H01G 9/06

(57) ABSTRACT

The capacitor has an electrode stack with faces between one or more edges. A bent portion of the one or more edges has a bend in the one or more edges. An adhesive film is positioned on the electrode stack such that an edge region of the adhesive film is over the bent portion of the one or more edges. The adhesive film includes multiple flaps. The multiple flaps include a first flap connected to a first portion of the edge region and a second flap connected to a second portion of the edge region. The first flap and the second flap are positioned over a first one of the faces of the electrode stack. A lateral edge of the first flap intersects a lateral edge of the second flap at a common location.

### RELATED APPLICATIONS

This application is a continuation of U.S. Patent Application Ser. No. 63/452,157, filed Mar. 14, 2023, entitled “Fabrication Of Capacitors”, and incorporated herein in its entirety.

### FIELD

The invention relates to energy storage devices. In particular, the invention relates to capacitors.

### BACKGROUND

The performance of many capacitors applications is enhanced as the holding capacity of the capacitor increases. As an example, increasing the holding capacity of the capacitors in devices such as Implantable Cardioverter Defibrillators (ICDs) allows the size of the ICDs to be reduced.

The capacity of the anodes used in many capacitor configurations has been substantially increased. However, the capacitors that use these anodes have not seen a commensurate increase in holding capacity. The lack of a commensurate increase in the holding capacity is believed to be a result of the capacitor becoming cathode limited. As a result, there is a need for improved capacitors and improved methods of capacitor fabrication.

Additionally, many capacitors employ a stack of electrodes where anodes alternate with cathodes. The stack is placed in a case with an insulator between the stack and the case in order to insulate portions of the electrode stack from the case. Examples insulators include electrically insulating boots that receive a portion of the electrode stack and electrically insulating tapes. Insulating tape is difficult to conform to an electrode stack because the presence of corners and curves along the edges of the electrode stack cause the insulating tape to wrinkle and/or pleat. Additionally, insulating boots add considerable expense to the cost of the capacitor. As a result, there is a need to improve the electrical insulation between the electrode stack and the capacitor case.

### SUMMARY

Fabricating a capacitor includes forming a mask on a sheet of a cathode metal. A layer of a porous material is formed on the sheet of the cathode metal after forming the mask. The mask is removed from the sheet of the cathode metal so as to define one or more open regions and one or more porous regions on the cathode metal. Each of the one or more porous regions of the cathode metal are under the porous material while each of the one or more open regions of the cathode metal are not under the porous material. The one or more open regions of the cathode metal are cut so as to separate a cathode precursor from the sheet of the cathode metal.

An electrolytic capacitor has a cathode that includes a porous material on a cathode metal. A face of the cathode metal includes a shelf that is not under the porous material. The shelf extends out from under the porous material to an edge of the cathode metal. At least a portion of the shelf has a width that is greater than 0 inches and less than 0.1 inches. The width of the shelf is measured in a direction that is perpendicular to a footprint of the porous material on the cathode metal.

A capacitor can have an electrode stack with faces between one or more edges. A bent portion of the one or more edges has a bend in the one or more edges. An adhesive film is positioned on the electrode stack such that an edge region of the adhesive film is over the bent portion of the one or more edges. The adhesive film includes multiple flaps. The multiple flaps include a first flap connected to a first portion of the edge region and a second flap connected to a second portion of the edge region. The first flap and the second flap are positioned over a first one of the faces of the electrode stack. A lateral edge of the first flap intersects a lateral edge of the second flap at a common location.

An electrolytic capacitor has an electrode stack in an interior of a case. The electrode stack has faces between one or more edges. The case has a layer of an electrical insulator immobilized on a layer of an electrical conductor. The layer of the electrical insulator is between the one or more edges of the electrode stack and the layer of the electrical conductor.

### BRIEF DESCRIPTION OF THE FIGURES

FIG. 1A through FIG. 1G illustrate the construction of a capacitor. FIG. 1A is a sideview of an anode that is suitable for use in the capacitor.

FIG. 1B is a cross-section of the anode shown in FIG. 1A taken along the line labeled B in FIG. 1A.

FIG. 1C is a sideview of a cathode that is suitable for use in the capacitor.

FIG. 1D is a cross-section of the cathode shown in FIG. 1C taken along the line labeled D in FIG. 1C.

FIG. 1E is a cross section of an electrode assembly where anodes are alternated with cathodes. The anodes and cathodes can be constructed according to FIG. 1A through FIG. 1D.

FIG. 1F is a schematic diagram of a capacitor that includes the electrode assembly of FIG. 1E positioned in a capacitor case.

FIG. 1G is a sideview of an interface between an anode and a cathode that are adjacent to one another in the capacitor of FIG. 1F.

FIG. 2A through FIG. 2K illustrate a method of generating a cathode for use in a capacitor constructed according to FIG. 1A through FIG. 1G. FIG. 2A is a topview of a sheet of cathode metal from which the cathode is constructed.

FIG. 2B is a topview of a sheet of material that includes a mask on the sheet of cathode metal. The mask defines a cathode precursor on the sheet of material.

FIG. 2C and FIG. 2D illustrate a porous material positioned on the sheet of material metal of FIG. 2B. FIG. 2C is a topview of the sheet of material.

FIG. 2D is a cross section of the cathode precursor shown in FIG. 2C taken along the line labeled D in FIG. 2C.

FIG. 2E and FIG. 2F illustrate removal of the mask from the sheet of material shown in FIG. 2C and FIG. 2D. FIG. 2E is a topview of the sheet of material.

FIG. 2F is a cross section of the sheet of material shown in FIG. 2E taken along the line labeled F in FIG. 2E.

FIG. 2G through FIG. 2I illustrate extraction of a cathode precursor from the sheet of material of FIG. 2E and FIG. 2F. FIG. 2G is a topview of the cathode precursor.

FIG. 2H includes a cross section of the cathode precursor shown in FIG. 2G taken along the line labeled H in FIG. 2G.

FIG. 2I includes a cross section of the cathode precursor shown in FIG. 2G taken along the line labeled H in FIG. 2G.

FIG. 2J and FIG. 2K illustrate the cathode precursor of FIG. 2G through FIG. 2I extracted from the sheet of material. FIG. 2J is a topview of the cathode precursor.

FIG. 2K is a cross section of the cathode precursor of FIG. 2J taken along the line labeled K in FIG. 2J.

FIG. 3 is a perspective view of an anode that is suitable for combining with the cathode precursor of FIG. 2J in an electrode assembly.

FIG. 4 is a perspective view of an electrode stack that can be used in an electrode assembly

FIG. 5A through FIG. 5D illustrate formation of terminals in an electrode stack. FIG. 5A is a perspective view of an electrode stack before the formation of the terminals.

FIG. 5B is a closer view of a portion of the electrode stack from FIG. 5A.

FIG. 5C is a perspective view of an electrode stack having terminals.

FIG. 5D is a closer view of a portion of the electrode stack from FIG. 5C.

FIG. 5E is a topview of a schematic of an electrode stack.

FIG. 6 is a perspective view of a portion of an adhesive film.

FIG. 7A is a topview of a portion of an adhesive film.

FIG. 7B illustrates the adhesive film of FIG. 7A having a flap curved upwards.

FIG. 7C is a perspective view of a portion of an electrode stack having a corner.

FIG. 7D is a perspective view of a portion of an electrode assembly having the adhesive film of FIG. 7A positioned on the electrode stack of FIG. 7C.

FIG. 7E is a cross section of the electrode assembly of FIG. 7D taken along the line labeled E in FIG. 7D.

FIG. 8A is a topview of a portion of an adhesive film.

FIG. 8B is a perspective view of a portion of an electrode stack having an edge with a corner.

FIG. 8C is a perspective view of a portion of an electrode assembly having the adhesive film of FIG. 8A positioned on the electrode stack of FIG. 8B.

FIG. 9A is a topview of a portion of an adhesive film.

FIG. 9B is a perspective view of a portion of an electrode stack having an edge with a curve.

FIG. 9C is a perspective view of a portion of an electrode assembly having the adhesive film of FIG. 9A positioned on the electrode stack of FIG. 9B.

FIG. 10A is a topview of a portion of an adhesive film.

FIG. 10B is a perspective view of a portion of an electrode stack having an edge with a curve.

FIG. 10C is a perspective view of a portion of an electrode assembly having the adhesive film of FIG. 10A positioned on the electrode stack of FIG. 10B.

FIG. 11A through FIG. 11C illustrate the application of adhesive films to a full electrode stack. FIG. 11A is a topview of multiple different adhesive films.

FIG. 11B is a perspective view of the adhesive films of FIG. 11A positioned on an electrode stack so as to provide an electrode assembly.

FIG. 11C is a cross-section of the electrode assembly shown in FIG. 11B taken along the line labeled C in FIG. 11B.

FIG. 11D is a topview of a first adhesive film.

FIG. 11E is a topview of a second adhesive film.

FIG. 11F is a perspective view of the first adhesive film from FIG. 11D and the second adhesive film from FIG. 11E positioned on an electrode stack so as to provide an electrode assembly

FIG. 12A is a topview of an adhesive film.

FIG. 12B is a perspective view of the adhesive films of FIG. 12A positioned on an electrode stack so as to provide an electrode assembly.

FIG. 13A through FIG. 13D illustrate assembly of a capacitor using a single adhesive film. FIG. 13A is an exploded view of an example of a case that is suitable for use with a capacitor.

FIG. 13B illustrates an adhesive film suitable for use with the case of FIG. 13A. FIG. 13B includes a topside view and a bottom sideview of the adhesive film.

FIG. 13C is a perspective view of the adhesive film of FIG. 13B positioned in a recess in a base of the case shown in FIG. 13A.

FIG. 13D is a perspective view of an electrode stack received in the recess of FIG. 13C on top of the adhesive film.

FIG. 13E illustrates a cover for the case of FIG. 13A attached to the base of the case.

FIG. 14A is a perspective view of a base for a capacitor case.

FIG. 14B is a perspective view of a cover for a capacitor case.

FIG. 14C is a perspective view of an electrode stack received in a recess in the base of FIG. 14A.

FIG. 14D is a perspective view of a capacitor constructed with an electrode stack positioned in the base of FIG. 14A and the cover of FIG. 14B.

FIG. 14E is a cross section of the capacitor shown in FIG. 14D taken along the line labeled E in FIG. 14D.

FIG. 14F is a cross section of another embodiment of the capacitor shown in FIG. 14D taken along the line labeled E in FIG. 14D

### DESCRIPTION

The holding capacity of a cathode limited capacitor can be increased by increasing the capacity of the one or more cathodes in the capacitor. The cathodes used in capacitors generally include a cathode metal such as titanium. The capacity of the cathode can be increased by forming a layer of a porous material on the cathode metal. The presence of pores in the porous material increases the surface area of the cathode. The increased surface area increases the capacity of the cathode.

Cathodes are fabricated from a sheet of material that has a layer of porous material on the cathode metal. The cathode metal has porous material regions and open regions. The porous material is over the porous material regions but is not over the open regions. The open regions are positioned on the cathode metal such that cathode precursors can be cut from the sheet of material by cutting through the cathode metal at the open regions.

The cathodes are generally cut from a sheet of material using a wire such as a molybdenum wire or a brass wire as the tool electrode in an Electrical Discharge Machining process. However, the increased hardness of the porous material can increase the rate of wire erosion making the sheet of material more difficult to cut. This increase in cutting difficulty increases the amount of wire that is needed to cut the sheet of material. As a result, the costs of cathode production increase and the efficiency of cathode production drops. Since the cutting occurs at the open regions, the cutting mechanism does not cut, or does not substantially cut, the porous material. As a result, the increased costs and lowered productivity associated with the presence of a porous material are reduced or eliminated while the increased capacity provided by the porous material are retained.

Additionally, in some instances, the cathode metal in a cathode includes one or more welded components that are welded to components of other cathodes and/or to other components of a capacitor. For instance, a capacitor can include one or more cathodes that each includes one or more tabs that each serve as one of the welded components. All or a portion of the tabs from the same or different cathodes can be welded together. The presence of a porous material on the tabs can reduce the quality of the welds. However, the open regions are formed on the cathode metal so that the welded components fall within the open regions. Since the porous material is not over the open regions of the cathode metal when the cathode precursor is cut from the sheet of material, the porous material is not over the welded components after the cathode precursor is cut from the sheet of material. As a result, the welded components can be welded together without interference from the porous material.

The capacitor can have an adhesive film that acts as an insulator between an electrode stack and a case that holds the electrode stack. The electrode stack can have faces between edges. The adhesive film can have multiple flaps connected to an edge region. The edge region of the adhesive film can be positioned over the one or more edges of the electrode stack while the flaps are positioned over one of the faces on the electrode stack. The flaps are positioned such that the interface between adjacent flaps are positioned at bends in the edge of the electrode stack. The flaps can overlap one another on the face of electrode stack. The ability to overlap different flaps allows the edge region of the adhesive film to be bent at the interfaces between adjacent flaps without the need to form pleats or wrinkles in the flaps. Pleats and/or wrinkles can undesirably increase the thickness of the electrode stack and can interfere with closing the case of a capacitor by entering the space where welds are made. Since the adhesive films can be placed on the electrode stack without pleats or folds, the adhesive film can effectively replace one or more boots that are currently used with the electrode stacks of capacitors. Replacing these boots can decrease the cost and complexity associated with the assembly of the capacitors.

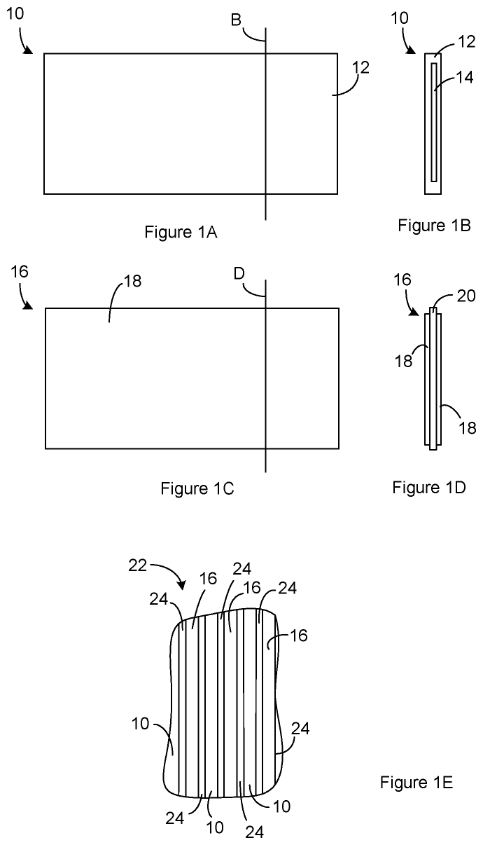

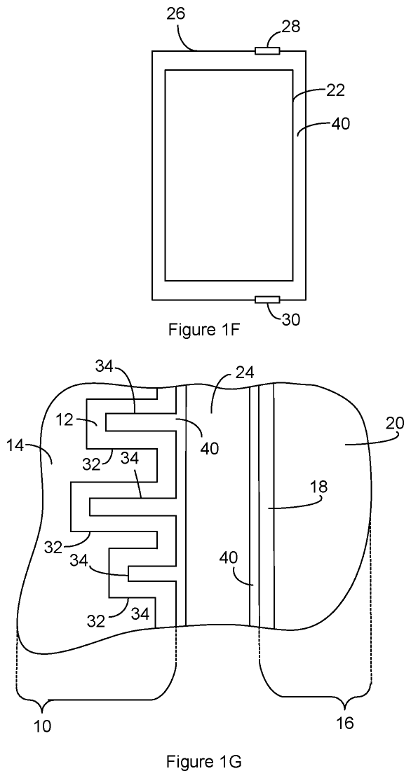

FIG. 1A through FIG. 1G illustrate the construction of a capacitor. FIG. 1A is a sideview of an anode 10 that is suitable for use in the capacitor. FIG. 1B is a cross-section of the anode 10 shown in FIG. 1A taken along the line labeled B in FIG. 1A. The anode 10 includes, consists of, or consists essentially of a layer of anode metal oxide 12 over a layer of an anode metal 14. Suitable anode metals 14 include, but are not limited to, aluminum, tantalum, magnesium, titanium, niobium, and zirconium. As illustrated in FIG. 1B, in some instances, the anode metal oxide 12 surrounds the anode metal 14 in that the anode metal oxide 12 is positioned on both the edges and the faces of the anode metal 14. Many anode metal oxides 12 can exist in more than one phase within the same material state (solid, liquid, gas, plasma). For instance, an anode metal oxide 12 such as aluminum oxide can be in a boehmite phase (AlO(OH)) that is a solid or in alpha phase corundum oxide (α-Al₂O₃) that is also a solid.

FIG. 1C is a sideview of a cathode 16 that is suitable for use in the capacitor. FIG. 1D is a cross-section of the cathode 16 shown in FIG. 1C taken along the line labeled D in FIG. 1C. The cathode 16 includes a layer of a porous material 18 over a layer of a cathode metal 20. The cathode metal 20 is generally non-porous but can be porous. Suitable cathode metals 20 include, but are not limited to, aluminum, titanium, and stainless steel. Although not illustrated, the cathode metal can be layer of material on a substrate. For instance, the cathode metal can be a titanium. Examples of suitable substrates include, but are not limited to, aluminum, titanium, and stainless steel substrates. The cathode metal 20 can be the same as the anode metal 14 or different from the anode metal 14.

The porous material 18 can be an electrically conducting material. In some instances, the porous material 18 includes or consists of one or more metals. In some instances, the porous material 18 includes or consists of nitrogen and one or more metals. The one or more metals in the porous material 18 can include or consist of the cathode metal. In one example, the porous material is selected from the group consisting of titanium nitride and titanium. In some instances, the porosity of the porous material is such that a ratio of an actual surface area of the porous material to the apparent surface area of the porous material per micron thickness of the porous material is greater than 2:1/μm or 50:1/μm and less than 300/μm or less than 1000/μm. The apparent surface area of the porous material represents the surface area of the porous material if the porous material were non-porous.

The anodes 10 and cathodes 16 are generally arranged in an electrode assembly 22 where one or more anodes 10 are alternated with one or more cathodes 16. For instance, FIG. 1E is a cross section of an electrode assembly 22 where anodes 10 are alternated with cathodes 16. The anodes 10 and cathodes 16 can be constructed according to FIG. 1A through FIG. 1D. A separator 24 is positioned between anodes 10 and cathodes 16 that are adjacent to one another in the electrode assembly 22. The electrode assembly 22 typically includes the anodes 10 and cathodes 16 arranged in a stack or in a jelly roll configuration. Accordingly, the cross section of FIG. 1E can be a cross section of an electrode assembly 22 having multiple anodes 10 and multiple cathodes 16 arranged in a stack. Alternately, the cross section of FIG. 1E can be created by winding one or more anodes 10 together with one or more cathodes 16 in a jelly roll configuration. However, as the anodes become more brittle due to increased surface area, it may not be practical or possible to form a jelly-roll configuration. Suitable separators 24 include, but are not limited to, Kraft paper, fabric gauze, and woven for non-woven textiles made of one or a composite of several classes of nonconductive fibers such as aramids, polyolefins, polyamides, polytetrafluoroethylenes, polypropylenes, and glasses. Although FIG. 1E illustrates a single anode between neighboring cathodes, in some instances, the electrode assembly is assembled with multiple anodes between neighboring cathodes.

The electrode assembly 22 is included in a capacitor. For instance, FIG. 1F is a schematic diagram of a capacitor that includes the electrode assembly 22 of FIG. 1E positioned in a capacitor case 26. Although not illustrated, the one or more anodes in the electrode assembly 22 are in electrical communication with a first terminal 28 that can be accessed from outside of the capacitor case 26. The one or more cathodes 16 in the electrical assembly are in electrical communication with a second terminal 30 that can be accessed from outside of the capacitor case 26. In some instances, the capacitor case 26 serves as one of the first terminal or as the second terminal. In some instances, the one or more anodes include or are connected to tabs (not shown) that provide electrical communication between the one or more anodes and the first terminal 28 and the one or more cathodes 16 include or are connected to tabs (not shown) that provide electrical communication between the one or more cathodes 16 and the second terminal 30. The capacitor can include one or more electrical insulators (not shown) positioned as needed to prevent shorts-circuits within the capacitor.

FIG. 1G is a sideview of an interface between an anode 10 and a cathode 16 that are adjacent to one another in the capacitor of FIG. 1F. The illustration in FIG. 1G is magnified so it shows features of the anode 10 and cathode 16 that are not shown in FIG. 1A through FIG. 1E. The face of the anode 10 includes channels 32 that extend into the anode metal 14 so as to increase the surface area of the anode metal 14. Although the channels 32 are shown extending part way into the anode metal, all or a portion of the channels 32 can extend through the anode metal. Suitable channels 32 include, but are not limited to, pores, trenches, tunnels, recesses, and openings. In some instances, the channels 32 are configured such that the anode has a number of channels/area greater than or equal to 30 million tunnels/cm². The anode metal oxide 12 is positioned on the surface of the anode metal 14 and is positioned in the channels 32. The anode metal oxide 12 can fill the channels 32 and/or anode oxide channels 34 can extend into the anode metal oxide 12. However, it is generally not desirable for the anode metal oxide 12 to fill the channels 32 because filling the channels 32 can lead to reduced capacitance and electrical porosity.

An electrolyte 40 is in contact with the separator 24, the anode 10 and the cathode 16. The electrolyte 40 can be positioned in the anode oxide channels 34. When the cathode metal 20 includes oxide channels, the electrolyte 40 can be positioned in the cathode oxide channels. The electrolyte 40 can be a liquid, solid, gel or other medium and can be absorbed in the separator 24. The electrolyte 40 can include one or more salts dissolved in one or more solvents. For instance, the electrolyte 40 can be a mixture of a weak acid and a salt of a weak acid, preferably a salt of the weak acid employed, in a polyhydroxy alcohol solvent. The electrolytic or ion-producing component of the electrolyte 40 is the salt that is dissolved in the solvent.

A capacitor constructed according to FIG. 1A through FIG. 1G can be an electrolytic capacitor such as an aluminum electrolytic capacitor, a tantalum electrolytic capacitor or a niobium electrolytic capacitor. An electrolytic capacitor is generally a polarized capacitor where the anode metal oxide 12 serves as the dielectric and the electrolyte 40 effectively operates as the cathode 16.

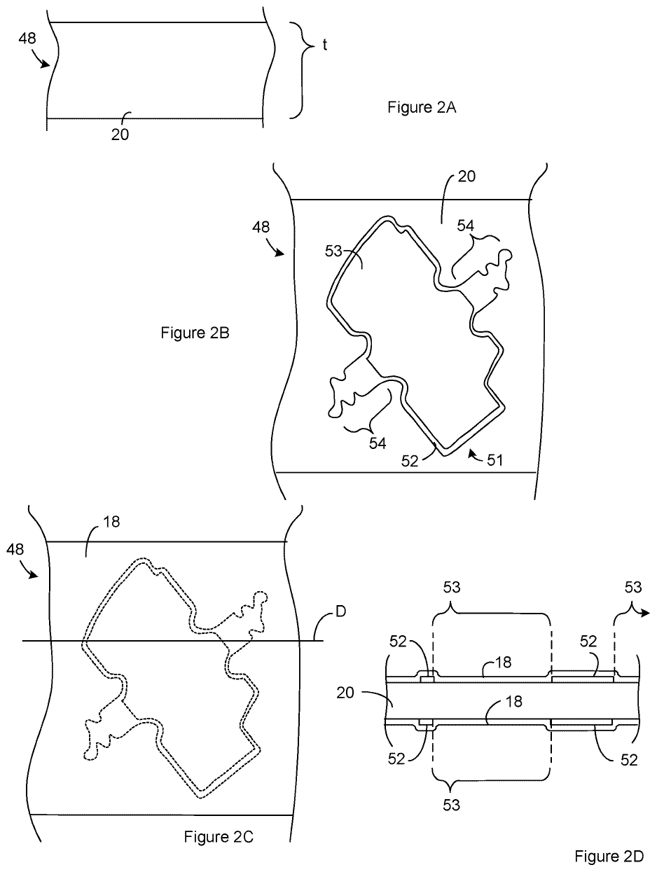

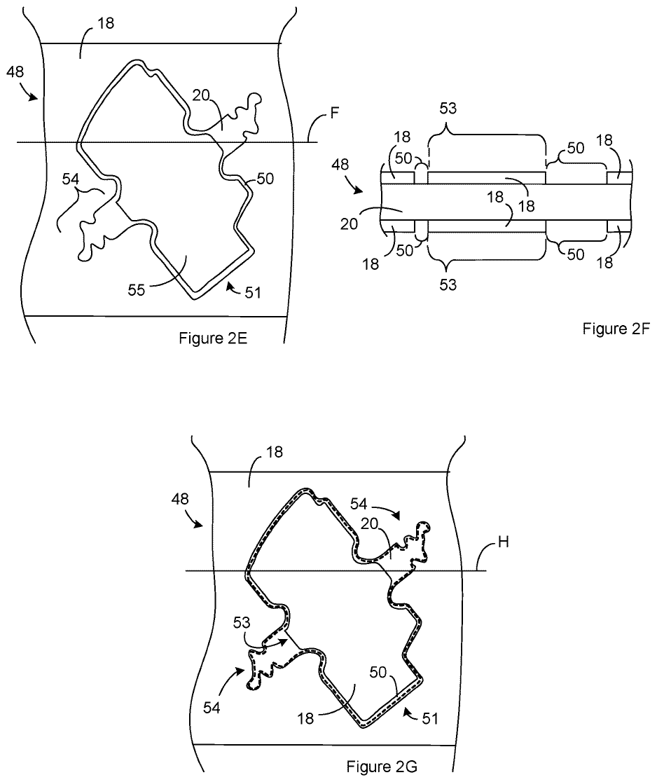

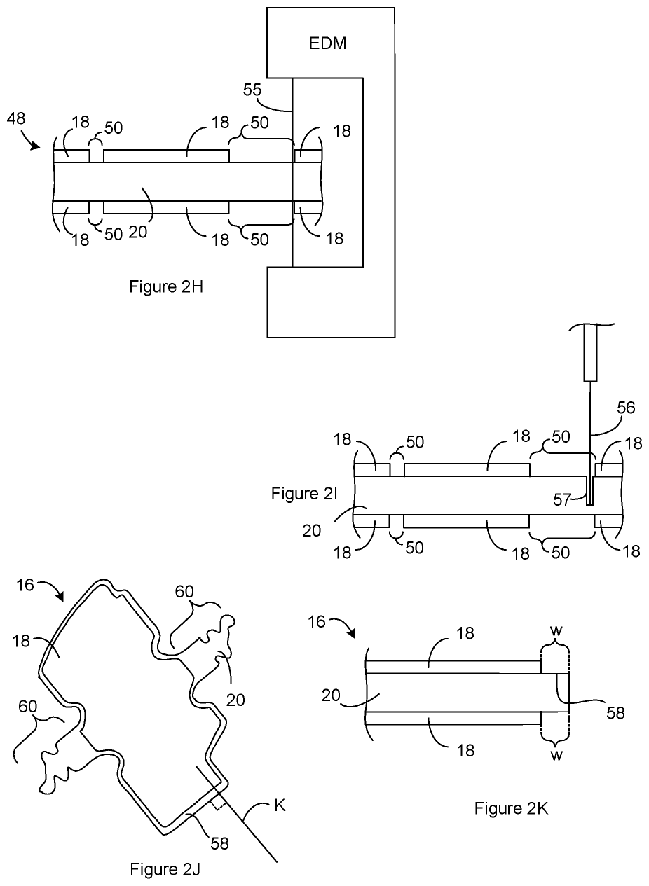

FIG. 2A through FIG. 2K illustrate a method of generating a cathode for use in a capacitor constructed according to FIG. 1A through FIG. 1G. A sheet of cathode metal 48 can be acquired either by fabrication or purchase from a supplier. As will be evident below, one or more cathodes are constructed from the sheet of cathode metal 48. FIG. 2A is a topview of the sheet of cathode metal 48 and shows faces of the sheet positioned between edges. The sheet of cathode metal 48 can include, consist of, or consist essentially of the cathode metal 20. In one example, the cathode metal is titanium and the sheet of cathode metal 48 is a sheet of titanium.

The sheet of cathode metal 48 can have a thickness labeled “t” in FIG. 2A. In some instances, the thickness “t” of the sheet of cathode metal is greater than 1.0 μm, or 5 μm and less than 40.0 μm. As a result, in some instances, the cathode metal 20 in a cathode has a thickness greater than greater than 1.0 μm and less than 40.0 μm.

A mask 52 is formed on the sheet of cathode metal 48 so as to define a cathode precursor 51 in a sheet of material as illustrated in FIG. 2B. FIG. 2B is a topview of the sheet of material. As will become evident below, the mask 52 is positioned over the location where the edge of the cathode is desired. The mask 52 is also positioned over one or more tab regions 54 of the sheet of cathode metal 48. The one or more tab regions 54 are regions of the sheet of cathode metal where a tab will be formed for making electrical connections to the cathode. Accordingly, the mask 52 is configured to protect the edge of the cathode and welded components such as the one or more tab regions 54. In some instances, the cathode precursor and the resulting cathode excludes tabs.

A suitable mask 52 includes, but is not limited to, soft masks such as photoresists and acrylics or a hard mask such as an oxide. Suitable methods for forming the mask 52 on the sheet of material include, but are not limited to, ink-jet printing and photolithography.

The mask 52 is not positioned over one or more porous material regions 53 of the sheet of cathode metal 48. The one or more porous material regions 53 of the sheet of cathode metal 48 is the region(s) of the sheet of cathode metal 48 where the porous material will be positioned on the cathode metal. The mask 52 can surround at least one of the porous material region 53 on the cathode precursor. After formation of the mask 52, at least one of the porous material region 53 on the cathode precursor remains exposed and accessible.

The porous material 18 can be positioned on the sheet of cathode metal so as to provide the cathode precursor of FIG. 2C and FIG. 2D. FIG. 2C is a topview of the sheet of material. The dashed lines in FIG. 2C illustrate the location of features that are located under the porous material 18. FIG. 2D is a cross section of the sheet of material shown in FIG. 2C taken along the line labeled D in FIG. 2C. The porous material 18 is positioned over the porous material region 53. In some instances, the porous material 18 is positioned over the mask 52. A suitable thickness for the porous material 18 includes, but is not limited to, a thickness greater than 0.2 μm and less than 1.0 μm. As a result, in some instances, the cathode has a porous material 18 with a greater than 0.2 μm and less than 1.0 μm. In one example, the porous material 18 is titanium nitride (TiN) or titanium and the cathode metal is titanium. Suitable methods of positioning the porous material 18 on the cathode metal 20 include, but are not limited to, deposition. An example of a suitable method for depositing the porous material 18 on the cathode metal 20 include, but are not limited to, Physical Vapor Deposition (PVD), and Chemical Vapor Deposition (CVD).

The mask 52 can be removed so as to provide the sheet of material of FIG. 2E and FIG. 2F. FIG. 2E is a topview of the sheet of material. FIG. 2F is a cross section of the sheet of material shown in FIG. 2E taken along the line labeled F in FIG. 2E. The removal of the mask 52 also removes any porous material 18 positioned over the mask 52. As a result, the removal of the mask 52 forms one or more open regions 50 of the cathode metal 20 that are not located under the mask 52 and that are positioned over the location where the edge of the cathode metal is desired in the final cathode. Additionally, the one or more open regions 50 of the cathode metal 20 can include welded component regions. For instance, the tab regions 54 can be positioned within the perimeter of the one or more open regions 50. Suitable methods of removing the mask 52 include, but are not limited to, chemical removal processes.

The cathode precursor can be extracted from the sheet of material as illustrated in FIG. 2G and FIG. 2H. FIG. 2G is a topview of the cathode precursor. FIG. 2H is a cross section of the cathode precursor shown in FIG. 2G taken along the line labeled H in FIG. 2G. The dashed lines in FIG. 2G can represent a separation line. The separation line is positioned on the open region 50 of the cathode metal 20 and between different regions of the porous material 18. The separation line extends along the desired edge of the cathode. As a result, the separation line can surround the porous material region 53 and the one or more tab regions 54.

The cathode precursor can be extracted from the sheet of material by cutting the cathode precursor along the separation line. For instance, the open region of the cathode metal can be cut so as to separate the cathode precursor from the sheet of material. One example of a suitable method for cutting the cathode precursor includes using a wire 55 to cut through the open region 50 of the cathode metal 20 as shown in FIG. 2H. For instance, a wire used as the tool electrode in an Electrical Discharge Machining (EDM) system can cut through the open region 50 of the cathode metal 20 along the separation line. Suitable wires include, but are not limited to molybdenum wire. Suitable systems for wire cutting include, but are not limited to, wire-cut Electrical Discharge Machining (EDM) systems, wire Electrical Discharge Machining (EDM) systems, wire erosions systems, and wire burning systems. As is evident from FIG. 2H, the open regions 50 over the cathode metal 20 area can be aligned with the open regions 50 over the cathode metal 20 to reduce interactions between the cutting implement and the porous material 18.

Another option for extracting the cathode precursor from the sheet of material is laser cutting of the cathode metal through the open region 50 of the cathode metal. FIG. 2I illustrates a laser beam 56 cutting the cathode metal 20 along the separation line. FIG. 2I is a cross section of the cathode precursor shown in FIG. 2G taken along the line labeled H in FIG. 2G. As is evident from FIG. 2H and FIG. 2I, cutting the cathode metal 20 along the open region 50 forms an edge of the cathode metal 20 that extends into the open region 50 of the cathode metal 20 and through the cathode metal 20.

In some instances, a pulsed laser beam is used to cut the cathode precursor from the sheet of material. Short pulse durations are possible with pulsed lasers that can provide very high peak powers for moderately energetic pulses. Increased peak power can provide vaporization of the cathode metal during the laser cutting process. This vaporization can eject the material from any recess 57 or trench created in the sheet of material through the top of the sheet of cathode metal. Since the material is ejected from the sheet of cathode metal, the amount of material that re-solidifies and/or re-deposits on the sheet of cathode metal is reduced.

In some instances, the duration of a pulse of the laser beam is greater than 0 s, or a femtosecond (10⁻¹⁵ s) and/or less than a microsecond (10⁻⁶ s). In one example, the duration of the pulse is greater than 100 femtoseconds and less than 900 femtoseconds. The time between pulses is inversely related to the pulse frequency. Suitable pulse frequencies can be greater than 0 Hz, or 100 Hz, and/or less than 2000 kHz. In one example, the pulse frequency is in a range of 200 kHz to 600 kHz. In some instances, the duration of the pulse is greater than 0 s, or a femtosecond (10⁻¹⁵ s) and/or less than a microsecond (10⁻⁶ s) and the pulse frequency is greater than 0 Hz, or 100 Hz, or 100 kHz and/or less than 2000 kHz.

The power density of the laser beam at the cathode metal 20 can be at a level that a single pulse elevates the temperature of the sheet of cathode metal above the boiling point of the cathode metal and vaporizes the cathode metal. In some instances, power density of the laser beam is such that at least a portion of the sheet of cathode metal that is illuminated by the laser reaches the boiling point of the cathode metal and vaporizes in a period of time less than or equal to the duration of one pulse when the illuminated portion of the sheet of cathode metal is at temperature (23° C. or 25° C.) before the pulse. In an example where the cathode metal is aluminum, the pulse duration is 820 femtoseconds, the pulse frequency is 400,000 pulses per second, and the laser beam has a power density 7.99×10¹¹ W/cm² at the surface of the sheet of cathode metal. Suitable power densities include, but are not limited to, power densities greater than 0 W/cm², 1×10¹¹ W/cm² , or 2×10⁵ W/cm² and/or less than 9×10¹¹ W/cm², or 2×10⁵ W/cm¹² . The combination of elevated power densities and reduced pulse durations reduces the amount of heat transferred to the sheet of cathode metal. However, adjusting these parameters may not be sufficient to address the increase in deformation that can result from using laser cutting of the cathodes rather than stamped or punched cutting of the cathodes.

The path of the laser beam across the face of the sheet of cathode metal can be controlled by electronics and/or software. The electronics and/or software can move the laser beam relative to the sheet of cathode metal and/or the sheet of cathode metal relative to the laser beam. In FIG. 2G, the separation line represents the laser beam pathway during the process of cutting the cathode precursor from the sheet of cathode metal. As a result, the laser is incident on the cathode metal 20 during at least a portion of the laser cutting.

The cathode precursor extracted from the sheet of cathode metal 48 can serve as a cathode 16. For instance, the cathode precursor of FIG. 2G can be extracted from the sheet of cathode metal 48 so as to provide the cathode 16 of FIG. 2J and FIG. 2K. FIG. 2J is a topview of the cathode. FIG. 2K is a cross section of the cathode of FIG. 2J taken along the line labeled K in FIG. 2J. The line labeled K in FIG. 2J is perpendicular to the edge of the cathode and/or perpendicular to the porous material 18.

The process of extracting the cathode precursor extracted from the sheet of cathode metal 48 can leave a shelf 58 of the cathode metal 20. The shelf can be a portion of the face of the cathode metal 20 that extends out from under the porous material 18 to an edge of the cathode metal 20. In some instances, the shelf is a portion of the face of the cathode metal 20 that extends out from under the porous material 18 to an edge of the cathode 16. The porous material 18 is not positioned over the shelf 58. In some instances, the cathode metal 20 in the shelf 58 is exposed. In some instances, the shelf 58 can surround the footprint of the porous material 18 on the cathode metal 20.

The portion of the one or more tab regions 54 that remain after the extraction of the cathode 16 from the sheet of cathode metal 48 serve as tabs 60 for the cathode 16. Accordingly, in some instances, one or more portions of the shelf 58 can serve as a tab 60 for the cathode 16. The one or more portions of the shelf 58 that are not included in a tab 60 can serve as the edge portion of the shelf. In some instances, the one or more edge portions of the shelf and the tabs 60 combine to surround the footprint of the porous material 18 on the cathode metal 20.

The edge portion of the shelf can have a width labeled “w” as shown in FIG. 2J. In some instances, at least a portion of the shelf 58 has a width (w) that is greater than 0.0 mm, and less than 0.2 inches where the width of the shelf is measured in a direction that is perpendicular to a footprint of the porous material on the cathode metal and/or perpendicular to an edge of the cathode metal. One or more portions of the shelf can have these widths for a distance with a length greater than 0.1 inch or 0.5 inch.

FIG. 2A through FIG. 2K illustrate the porous material 18, mask 52, porous material regions 53, and open regions 50 on both faces of the cathode metal 20, however, the method of FIG. 2A through FIG. 2K can be executed with the porous material 18, mask 52, porous material regions 53, and open regions 50 on a single face of the cathode metal 20.

The anodes can be fabricated as is suitable for use in the electrode assembly of a capacitor that includes one or more of the disclosed cathodes 16. The anodes can have a configuration that is suitable for stacking with the disclosed cathodes. An example of a suitable anode construction and/or anode fabrication includes, but is not limited to, the anode construction and/or anode fabrication disclosed in U.S. patent application Ser. No. 16/840,304, filed on Apr. 3, 2020, entitled “Reduction of Charging Time in Capacitors,” and incorporated herein in its entirety.

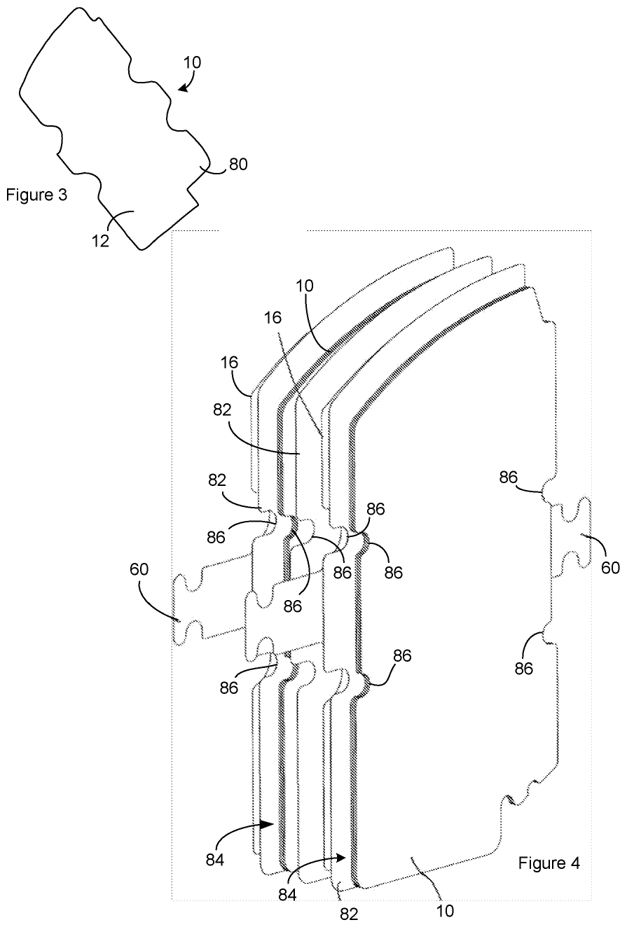

FIG. 3 is a perspective view of an anode that is suitable for combining with the cathodes of FIG. 2J in an electrode assembly. The anode metal 14 includes a connecting portion 80. When the anode 10 is included in a stacked electrode assembly, the connecting portion 80 can extend out from between adjacent cathodes 16. The connecting portion 80 can be used to establish electrical communication between a terminal of the capacitor and the anodes in the electrical assembly.

The electrodes are stacked so as to form an electrodes stack. FIG. 4 is a perspective view of an electrode stack that can be used in an electrode assembly. In order to simplify the illustration, the details of the construction of the cathode 16 and anode 10 are not shown. The electrode assembly includes cathodes 16, separators 82 and anodes 10. The anodes 10 are arranged in multiple different sets 84. Each set 84 of anodes 10 is separated by a cathode 16 which is disposed between two separators 82. The edges of the cathodes 16, separators 82 and anodes 10 include recesses 86 that are aligned. The recesses 86 can be used to achieve the proper alignment of electrodes and separators in the electrode stack. Suitable separators 82 include, but are not limited to, Kraft paper, synthetic insulating materials, natural fiber insulating materials, and cellulose insulating materials.

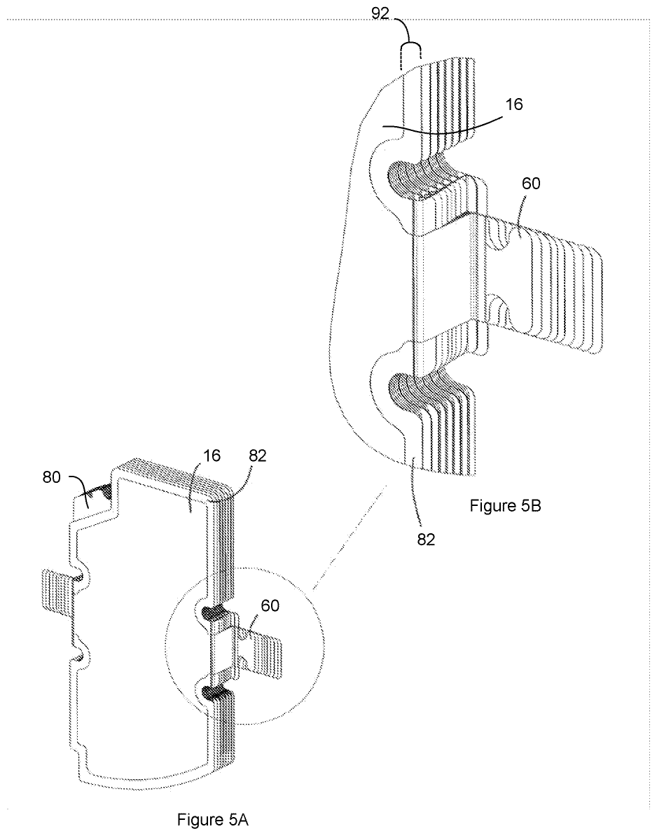

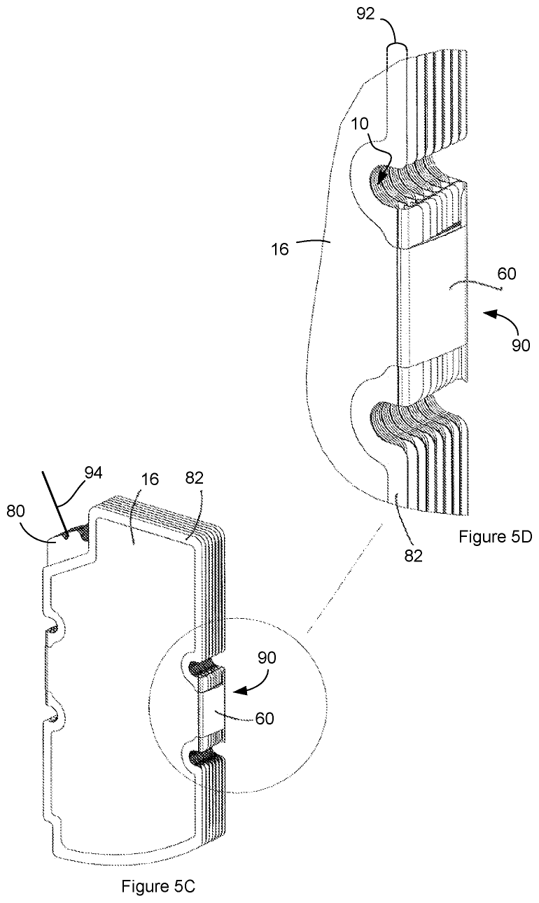

The tabs 60 of the cathodes 16 in the electrode stack of FIG. 4 can be joined to one another. For instance, a single cathode terminal 90 can be formed from the tabs 60 by compressing the tabs 60 on one side of the electrode stack together and bending the compressed tabs 60 towards the opposing side of the electrode stack as shown in FIG. 5A and FIG. 5B. The tabs 60 can then be joined together through an approach such as welding. The lack of the porous material on the tabs 60 increases the quality of welding results. The welded tabs 60 can be bent back across the electrode stack to provide cathode terminals 90 for the electrode stack as shown in FIG. 5C and FIG. 5D. The welded tabs can be connected to a face of a cathode on the top or bottom of the electrode stack so as to provide electrical communication between the welded tabs and the cathode. For instance, the welded tabs can be connected to and/or immobilized relative to the stack using an approach such as taping the welded tabs to a face of the electrode stack. The separators can each have an extended portion 92 that extends beyond the edges of the cathodes as shown in FIG. 4 through FIG. 5D. The extended portion 92 can be bent so as to be located between the tabs 60 and the edges of the anode 10 as shown in FIG. 5D. The location of the extended portion 92 between the tabs 60 and the edges of the anode 10 can prevent arc discharge or shorting. The connecting portions 80 of the anodes 10 can be connected to an electrical conductor 94 such as a wire using techniques such as welding.

In order to simplify the following discussion, the topview of an electrode stack can be illustrated as shown in FIG. 5E. The electrode stack has edges 100 between faces 102. Each edge 100 of the electrode stack is illustrated as a single surface but represents the collection of electrode edges that make up the perimeter of the electrode stack. The electrode stack can have shapes other than the illustrated shape.

Addition details regarding the construction and/or assembly of an electrode stack can be found in U.S. patent application Ser. No. 16/694,655, filed on Nov. 25, 2019, granted U.S. Pat. No. 11,342,128, entitled “Electrolytic Capacitor,” and incorporated herein in its entirety.

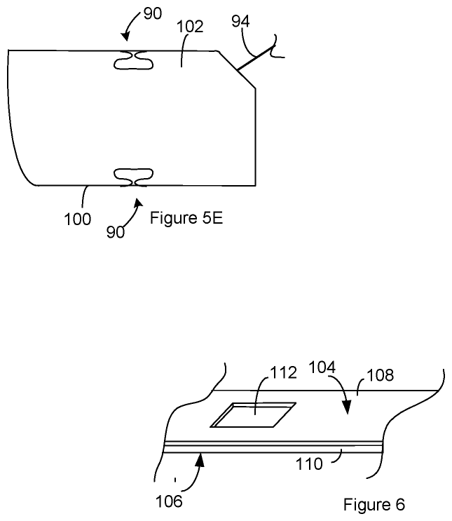

An electrical insulator can be positioned on the edges 100 of the electrode stack to prevent scintillations and reduce field related failures by eliminating arcing to a case for the capacitor. In some instances, the electrical insulator is an adhesive film such as tape. FIG. 6 is a perspective view of a portion of an adhesive film 98. The adhesive film 98 includes faces 104 between edges 106 that define the perimeter of the adhesive film 98.

The adhesive film 98 includes a layer of adhesive 108 on a flexible and electrically insulating substrate 110. Suitable adhesives 108 include, but are not limited to, acrylic adhesives and silicone adhesives. Suitable substrates 110 include, but are not limited to, plastics such as polyimides and Poly Ether Ether Ketone (PEEK). A suitable thickness for the adhesive film includes, but is not limited to, a thickness less than 0.005 inches. In some instances, the adhesive film is a piece of tape such as a piece of Poly Ether Ether Ketone tape (PEEK tape). PEEK tape is highly tolerant to the components of electrolytes that are often used in capacitors. For instance, PEEK tape is tolerant of the ammonia that is often present in electrolyte capacitors. Additionally, PEEK tape is tolerant of the high temperatures that are often present in capacitor preparation. For instance, PEEK tape does not become brittle at the temperatures that are used during aging and other testing of capacitors.

The illustrated adhesive film does not have the layer of adhesive 108 on one of the faces of the substrate. The face of the substrate that has the layer of adhesive 108 can include one or more exposed regions 112 where the adhesive is not positioned over the substrate 110. Additionally, one or both sides of the substrate 110 can include one or more covered regions 114 where the adhesive is positioned over the substrate 110. The one or more exposed regions 112 can be positioned on the adhesive film 98 such that when the adhesive film 98 is positioned on the electrode assembly 22, the one or more exposed regions 112 are positioned over one or more edges 100 of the electrode assembly 22. As a result, the adhesive does not contact the edges 100 of the electrode assembly 22. An adhesive on the edges of an electrode can interfere with the formation of oxide on the edge of the electrode. The lack of adhesive over the edge 100 of the electrode assembly 22 reduces the interference with the oxide formation on the edge of the electrodes. The portion of the one or more exposed regions 112 that is or will be positioned over the edges 100 of the electrode assembly 22 each serves as an edge region of the adhesive film. As a result, the adhesive film includes one or more edge regions. In some instances, the adhesive film is configured such that each of the one or more exposed regions 112 of an adhesive film serves as an edge region of an adhesive film.

The one or more covered regions 114 can be positioned on the adhesive film 98 such that when the adhesive film 98 is positioned on the electrode assembly 22, each of the one or more covered regions 114 is positioned over and adhered to one of the faces 102 of the electrode assembly 22.

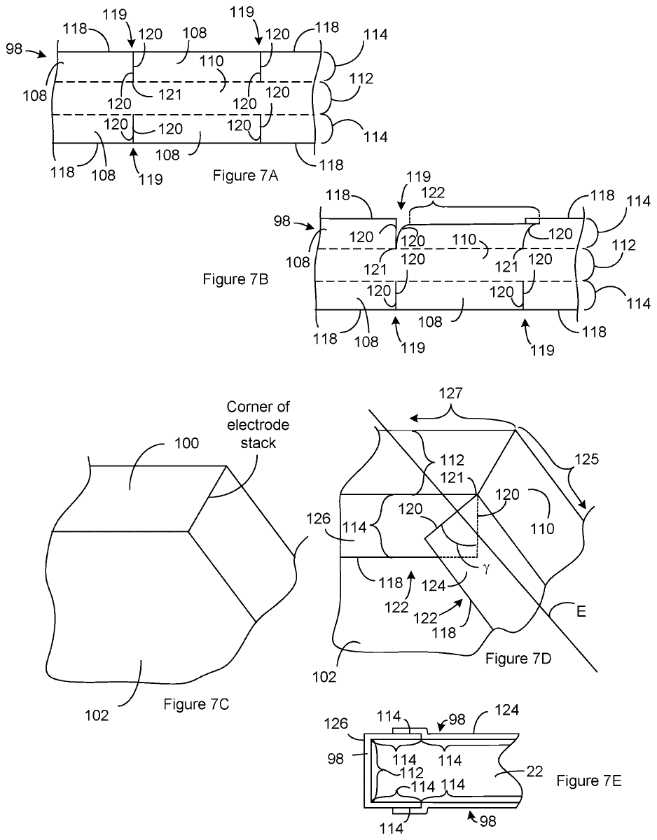

FIG. 7A is a topview of a portion of an adhesive film 98. The edges 106 of the substrate 110 include exterior edges 118 and multiple different sets 119 of lateral edges 120. Each of the lateral edges 120 extends from one of the exterior edges 118 toward a perimeter of an exposed region 112. In some instances, each of the lateral edges 120 spans the distance from one of the exterior edges 118 to the perimeter of an exposed region 112 as shown in FIG. 7A. The lateral edges 120 can be connected at one end by the substrate 110 at a common location 121. In some instances, the common location 121 is a point or a vertex. The substrate 110 is not positioned between the lateral edges 120 in the same set 119. As a result, a straight line can be drawn between the lateral edges in a set of lateral edges without the line extending through the adhesive film 98 and/or the substrate 110. The lateral edges 120 can be formed in an adhesive film 98 by making one or more cuts into the adhesive film 98. In some instances, the one or more cuts that form a set 119 of lateral edges extends through an exterior edge 120 of the adhesive film.

The portion of the adhesive film 98 positioned between lateral edges 120, between a lateral edge 120 and an exterior edge 118, or between exterior edges can act as a flap of the adhesive film 98. For instance, FIG. 7B illustrates the adhesive film 98 of FIG. 7A with a portion of the adhesive film 98 positioned between lateral edges 120 as a flap 122 of the adhesive film 98 that is curved upwards. In some instances, the lateral edges 120 from adjacent flaps 122 are from the same set 119 of lateral edges. The lateral edges 120 that define a flap can be connected by an exterior edge 118. Alternately, as will be discussed below, the lateral edges 120 that define the same flap can be connected.

The edges 100 of the electrode assembly 22 can include one or more bent regions that each includes a bend such as a curve or corner. For instance, FIG. 7C is a perspective view of a bent portion of an electrode stack having a corner. The adhesive film 98 of FIG. 7A is positioned on the electrode stack shown in FIG. 7C so as to provide the electrode assembly 22 of FIG. 7D. FIG. 7E is a cross section of the electrode assembly 22 of FIG. 7D taken along the line labeled E in FIG. 7D. The dashed lines in FIG. 7D illustrate the location of one flap 122 under another flap 122.

The exposed region 112 of the adhesive film is positioned over the edges 100 of the electrode stack. Accordingly, the exposed region 112 of the adhesive film can serve as an edge region of the adhesive film. As a result, the substrate 110 in the edge region of the adhesive film 98 can be in direct contact with the edges 100 of the electrode assembly 22.

The adhesive film 98 is conformed to the electrode assembly 22 such that the flaps 122 of the adhesive film 98 are positioned over and adhered to the faces 102 of the electrode stack. For instance, the adhesive film 98 can be folded and/or bent such so as to position the flaps 122 of the adhesive film 98 over the faces 102 of the electrode assembly 22. The flaps 122 have the adhesive located between the substrate and the faces 102 electrode assembly 22. As a result, the adhesive can immobilize the flaps 122 relative to the faces 102 electrode assembly 22 and can accordingly immobilize the adhesive film 98 on the electrode assembly 22.

A first one of the flaps 124 is connected to a first portion of the exposed region 125 and a second one of the flaps 126 is connected to a second portion of the exposed region 127. A lateral edge of the first flap 124 intersect a lateral edge of the second flap 126 at a common location 121. The first portion of the exposed region 125 is positioned over one side of the corner of the electrode stack and the second portion of the exposed region 127 is positioned over a second side of the corner of the electrode stack. The first portion of the exposed region 125 serves as a first portion of the edge region of the adhesive film and the second portion of the exposed region 127 serves as a second portion of the edge region of the adhesive film. Accordingly, the corner of the edge of the electrode stack is between the first portion of the edge region and the second portion of the edge region.

The lateral edges 120 of the adjacent flaps 122 shown in FIG. 7D extend away from the edge of the electrode stack and across the face of the electrode stack in different directions. For instance, the lateral edges 120 of the adjacent flaps 122 extend away from the common location 121 in different directions toward an interior of the face of the electrode assembly. The common location 121 can be located at or over the edge of the electrode stack. In particular, the common location 121 can be located at or over a bend in the edge of the electrode stack. In some instances, the common location is within a quarter inch, an eighth inch, a sixteenth inch, or a sixty fourth inch of the corner. The distance between the common location and the corner can be a result of rounding of the corner.

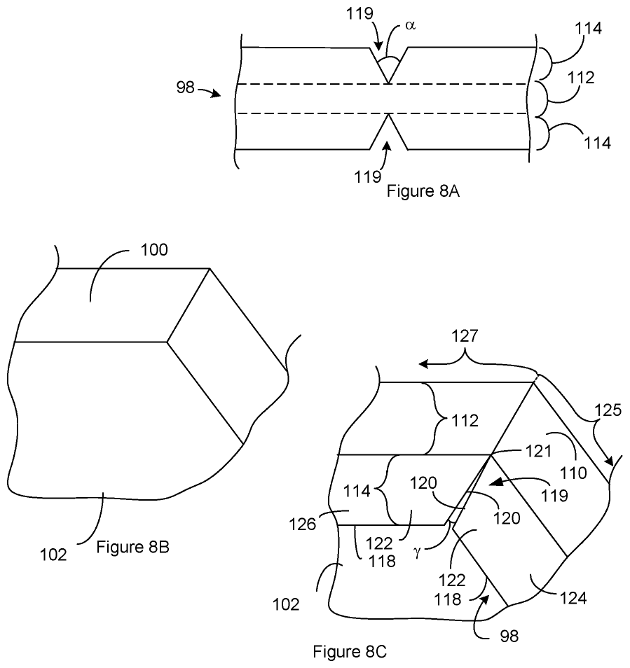

FIG. 7A illustrates the adhesive film 98 as having lateral edges that are straight and parallel when the adhesive film is laid flat, however, the lateral edges can be curved and/or non-parallel. As an example, FIG. 8A is a topview of an adhesive film 98 having multiple different sets 119 of lateral edges 120 that are straight and non-parallel. When the adhesive film 98 is laid flat, one or more sets 119 of lateral edges 120 can have lateral edges 120 angled at an angle α relative to one another as shown in FIG. 8A. In some instances, the angle α is greater than or equal to 0° or 10° and less than 120° or 145°. The angle α can apply to the full length of the lateral edges 120 in a set 119 or only a portion of the length of the lateral edges 120 in a set 119. The angle α for the sets 119 of lateral edges 120 shown in FIG. 7A is 0°.

FIG. 8B is a perspective view of a bent portion of an electrode stack having a corner. The adhesive film 98 of FIG. 8A is positioned on the corner of the stack shown in FIG. 8B so as to provide the electrode assembly 22 of FIG. 8C. The flaps 122 of the adhesive film 98 are positioned over and adhered to the faces 102 of the stack and the exposed region 112 of the substrate 110 is positioned over the edges 100 of the electrode stack and accordingly serves as an edge region of the adhesive film.

The lateral edges 120 of the adjacent flaps 122 shown in FIG. 8C extend away from the edge of the electrode stack and across the face of the electrode stack in different directions. For instance, the lateral edges 120 of the adjacent flaps 122 extend away from the common location 121 in different directions toward an interior of the face of the electrode assembly. The common location 121 can be located at or over the edge of the electrode stack. In particular, the common location 121 can be located at or over a bend in the edge of the electrode stack. In some instances, the common location is within the common location is within a quarter inch, an eighth inch, a thirty second inch, or a sixty fourth inch of the edge 100 of the electrode stack.

When the corner is a concave corner from the aspect of the electrode assembly, the folding of the flaps 122 onto the faces 102 of the electrode assembly 22 brings the lateral edges from adjacent flaps 122 closer together. The angle α can be selected such that the flaps 122 do not contact and the lateral edges 120 from adjacent flaps 122 are spaced apart as shown in FIG. 8C. Alternately, the angle α can be selected such that the lateral edges 120 from adjacent flaps 122 contact without the flaps overlapping. Alternately, the angle α can be selected such adjacent flaps 122 overlap as disclosed in the context of FIG. 7D. In some instances, the angle α is selected such that when the adhesive film 98 is positioned on the electrode assembly 22, the lateral edges from adjacent flaps have an angle relative to each other of γ as shown in FIG. 8C. In some instances, the angle γ is in a range of −90° to +90°, −90° to +10°, or −10° to +5° where negative values occur when the flaps that provide the lateral edges overlap as shown in FIG. 7D.

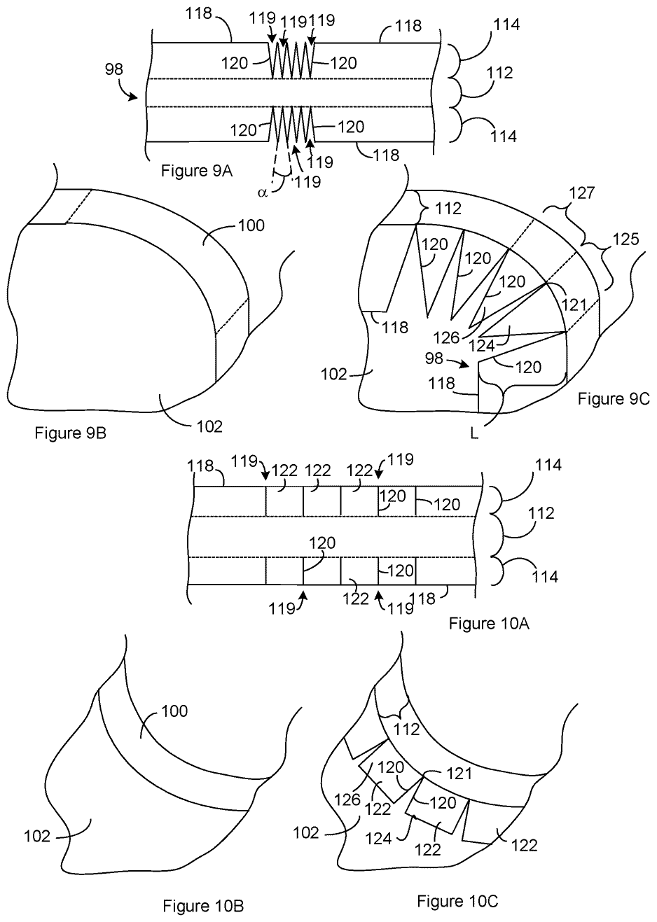

FIG. 7A through FIG. 8C illustrate the application of adhesive film 98 to a bend such as a corner. However, the edges of an electrode assembly 22 can have bends that are curves. The above lateral edge 120 configurations can be applied to the portion of an adhesive film 98 that will be conformed to a curve. For instance, FIG. 9A is a topview of an adhesive film 98 having multiple different sets 119 of lateral edges 120. The distance between adjacent sets 119 of lateral edges 120 is selected so to be useful with electrode assembly 22 edges having bends such as corners and curves.

In some instances where the opposing sides 120 in a set 119 are non-parallel, the lateral edges from adjacent flaps 122 intersect one another as shown in FIG. 9A. Each of the lateral edges 120 extends from another one of the lateral edges 120 toward a perimeter of an exposed region 112. In some instances, each of the lateral edges 120 spans the distance from another one of the lateral edges 120 to the perimeter of an exposed region 112.

When the lateral edges in a set 119 are non-parallel and the adhesive film is laid flat, the value of the angle α can be decreased as the radius of curvature of the bend that will be located under the set 119 of lateral edges increases. When the lateral edges 120 in adjacent sets 119 are parallel when the adhesive film is laid flat, the distance between the adjacent sets 119 can be increased as the radius of curvature of the bend that will be located under the set 119 of lateral edges increases.

FIG. 9B is a perspective view of a bent portion of an electrode stack having a bend such as a curve. The adhesive film 98 of FIG. 9A is positioned on the bend shown in FIG. 9B so as to provide the electrode assembly 22 of FIG. 9C. The reduced distance between adjacent sets of lateral edges 120 allows the adhesive film 98 to be conformed to the curved edge with the exposed region 112 of the substrate 110 positioned over the edges 100 of the electrode stack and the flaps 122 positioned over and adhered to the faces 102 of the electrode stack.

In FIG. 9C, a first one of the flaps 124 is connected to a first portion of the exposed region 125 and a second one of the flaps 126 is connected to a second portion of the exposed region 127. A lateral edge of the first flap 124 intersect a lateral edge of the second flap 126 at a common location 121. The first portion of the exposed region 125 is positioned over a first portion of the curve in the edge of the electrode stack and serves as a first portion of the edge region of the adhesive film. The second portion of the exposed region 127 is positioned over a second portion of the curve in the edge of the electrode stack and serves as a second portion of the edge region of the adhesive film.

Although FIG. 9A through FIG. 9C illustrate the sets 119 of lateral edges 120 having lateral edges 120 that are non-parallel when the adhesive film is laid flat, the lateral edges 120 can be parallel (α=0) when the adhesive film 98 is laid flat. When the lateral edges 120 are parallel when the adhesive film is laid flat but the adhesive film 98 is positioned over a bend in the edge of an electrode stack, the adjacent flaps can overlap as disclosed in the context of FIG. 7D.

The corners and edges illustrated in the electrode assembly 22 of FIG. 7A through FIG. 9C are concave from the perspective of the electrode assembly 22. However, the above adhesive film configurations can be applied to corners and edges that are convex from the perspective of the electrode assembly 22. For instance, FIG. 10A is a topview of an adhesive film 98 having multiple different sets 119 of lateral edges 120. The distance between adjacent sets 119 of lateral edges 120 is selected to be used with electrode assembly 22 edges having bends. The opposing sides 120 in the sets 119 are shown as parallel when the adhesive film is laid flat but can be non-parallel when the adhesive film is laid flat. When the opposing sides 120 in adjacent sets 119 are parallel when the adhesive film 98 is laid flat, the distance between the adjacent sets 119 can be increased as the radius of curvature of the bend that will be located under the set 119 of lateral edges increases.

FIG. 10B is a perspective view of a portion of an electrode stack having a curve that is convex from the perspective of the electrode stack. The adhesive film 98 of FIG. 10A is positioned on the curve shown in FIG. 10B so as to provide the electrode assembly 22 of FIG. 10C. The reduced distance between adjacent sets of lateral edges 120 allows the adhesive film 98 to be conformed to the curved edge with the exposed region 112 of the substrate 110 positioned over the edges 100 of the electrode stack and the flaps 122 positioned over the faces 102 of the electrode stack.

As is evident from FIG. 7A through FIG. 10C, the configuration of the lateral edges prevents the formation of wrinkles and/or pleats in the adhesive film that are often caused by the presence of bends in the edges of the electrode stack. Wrinkles and pleats in an adhesive film are often associated with the adhesive bonding together different regions on the same side of the substrate as a result of the adhesive film buckling and/or folding back upon itself. Additionally or alternately, wrinkles and pleats in an adhesive film are often associated with different regions of the substrate contacting one another without adhesive between the contacting regions as a result of the adhesive film buckling and/or folding back upon itself. For instance, wrinkles and/or pleats can be present in a flap 122 when the adhesive film turns or folds back upon itself one or more times such that a line perpendicular to a face of the electrode stack can pass through the same flap 122 two times, three times, or more than three times. In some instances, a wrinkles and/or pleat is present in a flap 122 when a line parallel to a face of the electrode stack can pass through the same flap 122 two or more times as can occur when a portion of the flap buckles upwards. Similarly, wrinkles and/or pleats can be present in an edge region of an adhesive film 98 when the adhesive film turns or folds back upon itself one or more times such that a line that is perpendicular to an edge of the electrode stack but does not pass through the electrode stack can pass through the edge region of the adhesive film 98 two times, three times, or more than three times. The formation of wrinkles and pleats is prevented by allowing the flaps 122 to be spaced apart and/or to stay substantially flat relative to a face of the electrode stack. For instance, FIG. 7E shows, the first flap 124 overlapping the second flap 126 in that a portion of the second flap 126 is between a portion of the first flap 124 and the electrode assembly 22. The portion of the second flap 126 is adhered to the back of the portion of the first flap. Accordingly, the region of each flap that contains adhesive (the covered region) is adhered either to a face of the electrode stack or to another flap rather than being lifted off of the face of the electrode stack as part of a wrinkle or pleat. As a result, the flaps 122 remain substantially flat on the face of the electrode stack and the adhesive film does not turn or fold back upon itself. When a region of a flap is adhered to a second flap, the region of the flap that is adhered to the second flap can be adhered to a face of the second flap that does not contain adhesive. Additionally, as shown in images such as FIG. 8C, the lateral edges from different flaps can be spaced apart from one another. The space between the lateral edges from different flaps eliminates the need to turn or fold the adhesive film back upon itself.

As is evident from the above illustrations, the flaps 122 extend from an edge of the electrode stack across a face of the electrode stack by a length. As an example, the length that a flap 122 extends across a face of the electrode stack is labeled L in FIG. 9C. A suitable length for all or a portion of the flaps 122 on an electrode assembly 22 to extends across a face of the electrode stack include lengths greater than or equal to a quarter of an inch or a half of an inch.

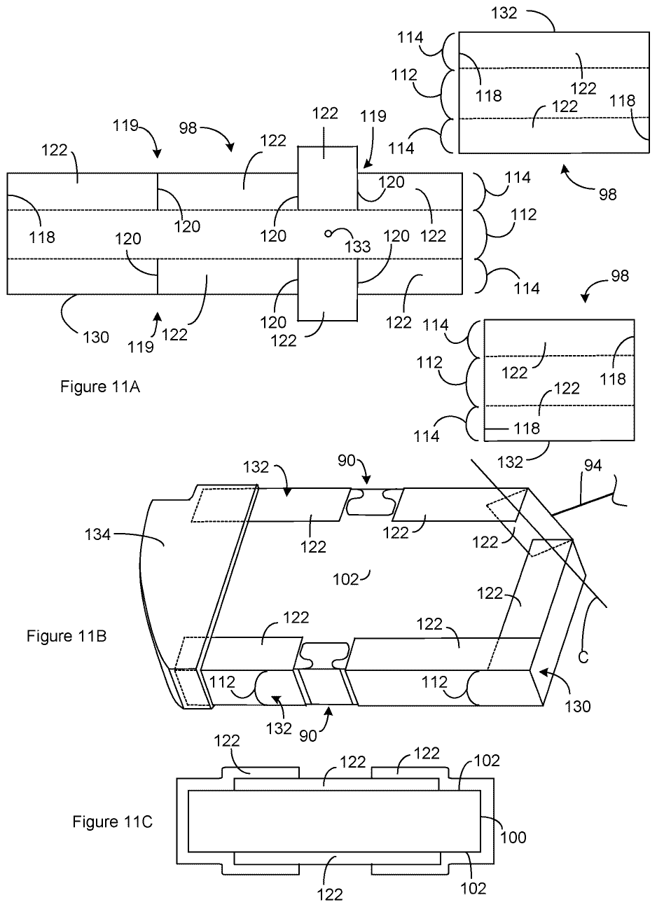

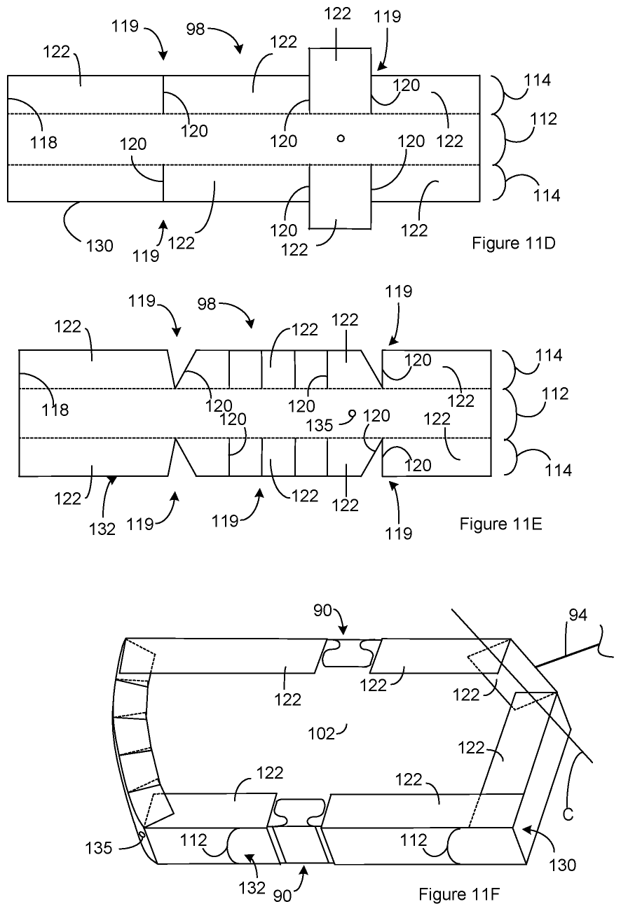

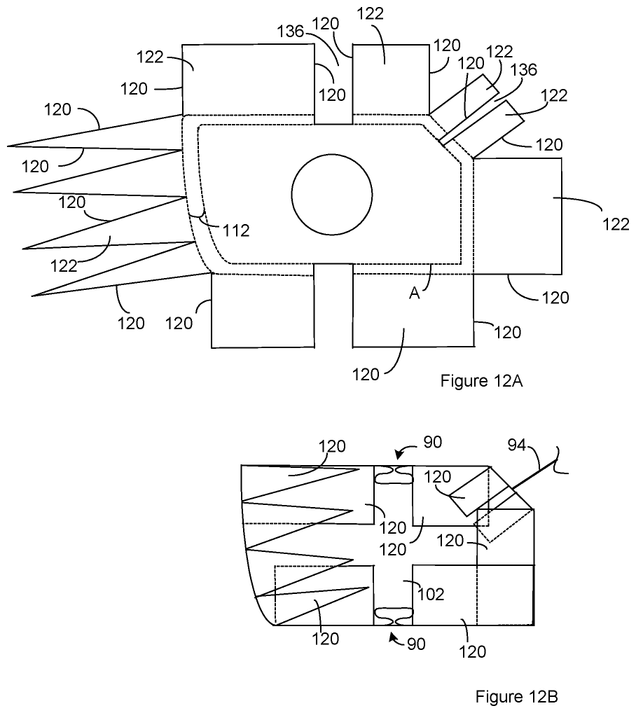

FIG. 11A through FIG. 11C illustrate the application of the above lateral edge 120 configurations to a complete electrode assembly 22. FIG. 11A is a topview of multiple different adhesive films 98. The adhesive films 98 include a first adhesive film 130 and two second adhesive films 132. The adhesive films 98 of FIG. 11A are positioned on an electrode stack so as to provide the electrode assembly 22 of FIG. 11B. FIG. 11C is a cross-section of the electrode assembly 22 shown in FIG. 11B taken along the line labeled C in FIG. 11B. The dashed lines in FIG. 11C illustrate the location of flaps under other components.

The first adhesive film 130 and two second adhesive films 132 are positioned on the electrode assembly such that the terminals 90 remain exposed and/or accessible, however, the one or more adhesive films on an electrode assembly can be positioned over one or more of the terminals. As a result, the terminals 90 can be accessed for electrical connection. The electrical conductor 94 passes through an opening 133 through the first adhesive film 130. A portion of the flaps 122 on the first adhesive film 130 are each defined by a lateral edge 120 and a portion of an exterior edge 118. The flaps 122 on the second adhesive films 132 have lateral sides that are defined by a portion of the exterior edges 118.

An electrode assembly 22 can include one or more boots that combine with one or more of the adhesive films 98 to form an electrical insulator over the edges of the electrode assembly. For instance, FIG. 11B and FIG. 11C illustrate a boot 134 positioned over a portion of the edges 100 on the electrode stack. None, one, or more than one of the adhesive films 98 can be positioned between the boot 134 and the electrode assembly 22. For instance, none, one, or more than one of the adhesive films 98 can be positioned between the boot 134 and the one or more edges 100 the electrode assembly 22. Additionally or alternately, none, one, or more than one of the adhesive films 98 can be positioned between the boot 134 and one or more faces 102 of the electrode assembly 22. In FIG. 11B, the adhesive films 98 have an exterior edge 118 that abuts the boot 134 over the one or more edges 100 the electrode assembly 22 and none of the adhesive films 98 is positioned between the boot 134 and the one or more edges 100 the electrode assembly 22. For instance, each of the second adhesive films 132 has an exterior edge 118 that abuts the boot 134 over the one or more edges 100 the electrode assembly 22 while neither of the second adhesive films 132 is positioned between the boot 134 and the one or more edges 100 the electrode assembly 22. FIG. 11B also illustrates the adhesive films 98 positioned between the boot 134 and the faces 102 the electrode assembly 22. For instance, a portion of each one of the second adhesive films 132 is positioned between the boot 134 and each one of the faces 102 the electrode assembly 22. At some locations on the electrode assembly 22, a boot can be preferable to an adhesive film because attachment of the boot to the electrode stack can be less complex than attachment of adhesive films. However, boots 134 tend to be expensive due to the fabrication process and/or material expenses.

The boot 134 can be constructed of an electrical insulator. As a result, the boot 134 can combine with one or more of the adhesive films 98 to form a continuous electrical insulator over one or more edges of the electrode assembly 22. For instance, FIG. 11B illustrates the boot 134 combining with the second adhesive films 132 to form a continuous electrical insulator over a portion of the electrode assembly 22 edges. Each of the boots can be pre-formed with a pocket into which the electrode assembly can inserted. In some instances, the pocket is configured such that the boot surrounds a portion of an electrode stack received within the pocket. For instance, as shown in FIG. 11B, the boot 134 can have a shape that conforms to one or more edges of the electrode assembly 22 as shown in FIG. 11B. The exterior surfaces of a boot can be designed to match the contours of the exterior of the electrode assembly 22 as shown in FIG. 11B. A boot can be held in place on an electrode assembly by mechanisms that include, but are not limited to, friction and a press fit. Additionally or alternately, one or more of the adhesive films can immobilize a boot on the electrode assembly. For instance, FIG. 11B illustrates the second adhesive films 132 positioned under the boot, however, one or more of the second adhesive films 132 can be partially positioned over so as to hold the boot in place on the electrode stack. Suitable materials for the boot 134 include, but are not limited to, Poly Ether Ether Ketones and polyimides.

An alternative to the boot 134 is to replace the boot 134 and the second adhesive films 132 with a single adhesive film 98. As a result, the electrode assembly 22 can include two adhesive films 98 that combine to form two different electrical insulators that are each over a different region of the electrode assembly 22 edges while not being positioned over the terminals 90. As an example, FIG. 11D through FIG. 11F illustrate an electrode assembly 22 with two adhesive films 98 that combine to form two different electrical insulators that are each over a different region of the electrode assembly 22. FIG. 11D is a topview of a first adhesive film 130 and FIG. 11E is a topview of a second adhesive film 132. FIG. 11F is a perspective view of the first adhesive film 130 from FIG. 11D and the second adhesive film 132 from FIG. 11E positioned on an electrode stack so as to provide an electrode assembly. The second adhesive film 132 from FIG. 11E replaces the boot 134 and the second adhesive film 132 from FIG. 11A and FIG. 11B. As shown in FIG. 11E, the second adhesive film 132 can optionally include an opening 135 in the exposed region 112. An electrolyte can be introduced into the electrode stack through the opening 135.

The first adhesive film 130 from FIG. 11D and the second adhesive films 132 from FIG. 11E can be combined to form a single adhesive film 130 that leaves the terminals 90 exposed or covers the terminals 90. However, the attachment of the adhesive film(s) to an electrode stack can become more difficult as the number of flaps increases. As a result, in some instances, it may be more desirable to use multiple adhesive films on an electrode stack.

A single adhesive film 98 can be used with an electrode assembly. For instance, FIG. 12A illustrates a single adhesive film 98 for use with an electrode stack. FIG. 12A is a topview of the adhesive film. The dashed line labeled A in FIG. 12A illustrate the location where the electrode stack is positioned before the flaps are folded up onto the face 102 of the electrode stack. Accordingly, the dashed line labeled A represents an electrode assembly perimeter. The portion of the adhesive film 98 located between the dashed line can exclude adhesive on the substrate and can accordingly serve as an exposed region 112. The adhesive can be positioned on each of the flaps 122. In some instances, the adhesive is positioned on the substrate within the dashed line labeled A and the region within the dashed line labeled A serves as a covered region. In some instances, the adhesive is not positioned on the substrate within the dashed line labeled A and the region within the dashed line labeled A serves as an exposed region.

The adhesive film 98 of FIG. 12A is positioned on an electrode stack so as to provide the electrode assembly 22 of FIG. 12B. The dashed lines in FIG. 12B illustrate the location of flaps 122 under other components of the electrode assembly. The adhesive film is positioned on the electrode stack such that the exposed region 112 of the substrate 110 is positioned over the edges 100 of the electrode stack and the flaps 122 are positioned over and adhered to a face 102 of the electrode stack. When an adhesive is positioned on the substrate within the dashed line labeled A in FIG. 12A, all or a portion of the region within the dashed line labeled A in FIG. 12A can be adhered to a face 102 on the underside of the electrode stack.

A comparison of FIGS. 12A and 12B shows that there are gaps 136 between opposed edges 120 that allow the terminals 90 to remain exposed and/or accessible and that allow the electrical conductor to pass through the adhesive film 98. The gaps can extend into or through an exposed region 112 so at least a portion of each gap 136 is over an edge of the electrode stack. FIG. 12B shows the gaps 136 extend through an exposed region 112. As a result of these gaps 136, the electrode assembly of FIG. 12B has four different portions of the exposed regions 112 positioned over the one or more edges of the electrode stack. In the electrode assembly of FIG. 11B, gaps between different adhesive films 98 and/or an opening through an adhesive films 98 serves as the gaps 136 illustrated in FIG. 12B.

In the electrode assembly 22 disclosed in the context of FIG. 11A through FIG. 11C, each flap 122 on a first face of the electrode assembly 22 can optionally correspond to a flap 122 on a second face of the electrode assembly 22. However, the electrode assembly 22 disclosed in the context of FIG. 12A through FIG. 12C does not have corresponding flaps on opposing faces of the electrode assembly 22 because the region of the adhesive film within the electrode assembly perimeter labeled A effectively replaces the flaps over on the faces of the electrode assembly.

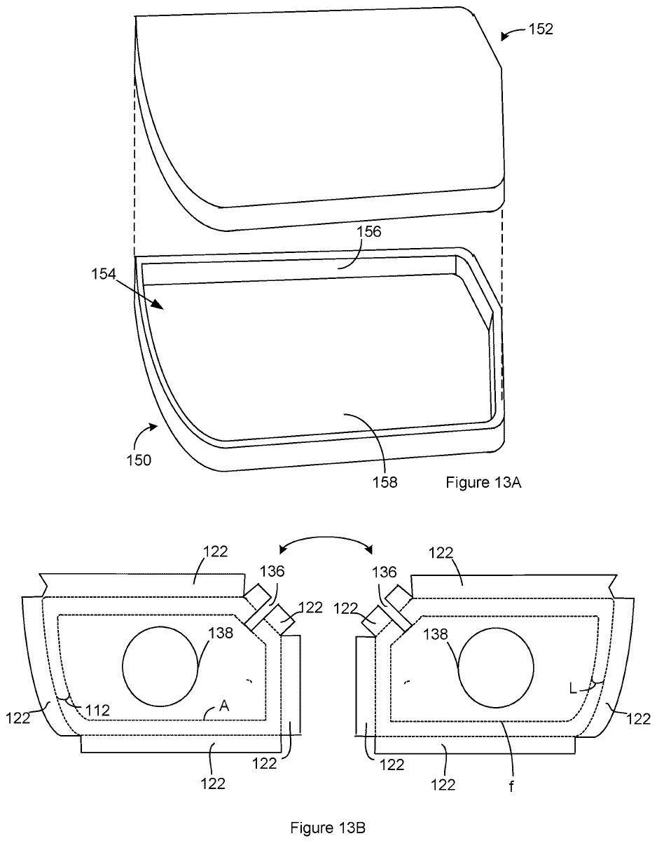

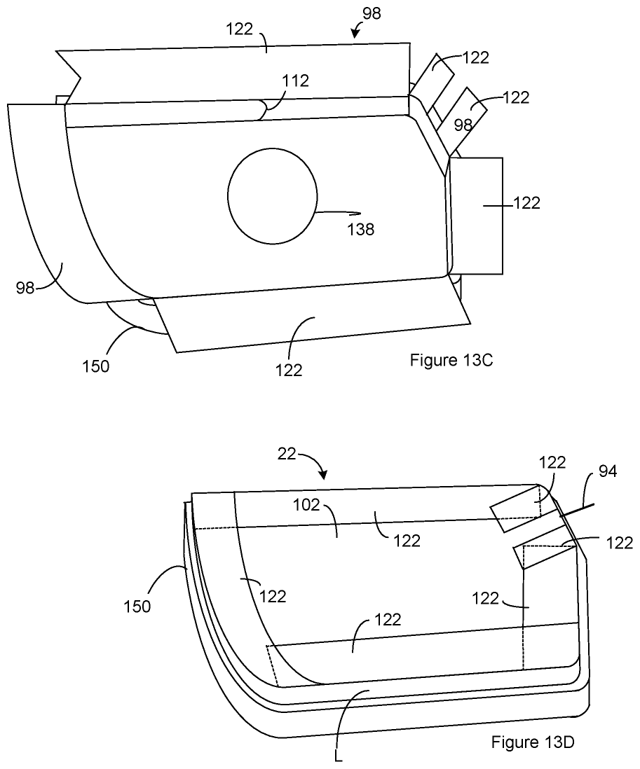

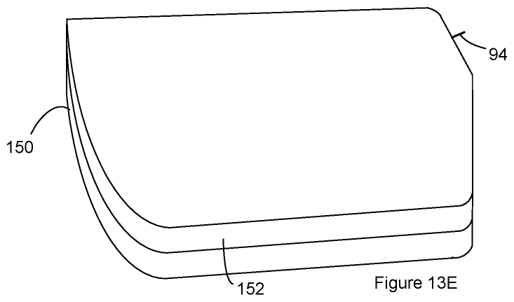

An electrode assembly can be positioned in a capacitor case. Alternately, one or more adhesive films can be positioned in or on a capacitor case before being attached to the electrode stack. FIG. 13A through FIG. 13E illustrate assembly of a capacitor using a single adhesive film. FIG. 13A is an exploded view of an example of a case that is suitable for use with a capacitor. The case has a base 150 and a cover 152 that can be joined together. A recess 154 can extend into the base 150 and/or the cover 152 so as to define an interior volume within the case. FIG. 13A illustrates a recess 154 extending into the base 150. The recess 154 has lateral sides 156 and a face side 158. The interior volume is sized to receive an electrode assembly when the base 150 is attached to the cover 152. The base 150 and cover 152 can be constructed of an electrical conductor such as a metal. Suitable materials for the base 150 and cover 152 include, but are not limited to, electrical conductors and metals such as stainless steel and aluminum.

FIG. 13B illustrates an adhesive film suitable for use with the case of FIG. 13A. FIG. 13B includes a topside view and a bottom sideview of the adhesive film. The dashed line labeled A in FIG. 13A illustrate the perimeter of the location where the electrode stack will be positioned on the adhesive film. Accordingly, the dashed line labeled A represents an electrode assembly perimeter. The portion of the adhesive film located between the dashed lines can exclude adhesive on the substrate and can accordingly serve as an exposed region 112. The backside of the exposed region 112 is labeled L in FIG. 13B and can serve as a lateral region of the adhesive film. The adhesive can be positioned on each of the flaps 122. In some instances, the adhesive is positioned on the substrate within the dashed line labeled A and the region within the dashed line labeled A serves as a covered region. In some instances, the adhesive is not positioned on the substrate within the dashed line labeled A and the region within the dashed line labeled A serves as an exposed region. The backside of the region within the dashed line labeled A is labeled f in FIG. 13B and can serve as a face region of the adhesive film. An opening 138 extends through the adhesive film.

The adhesive film can be positioned in a recess in the base or the cover before the electrode stack is positioned on the adhesive film. For instance, FIG. 13C is a perspective view of the adhesive film 98 of FIG. 13B positioned in a recess in the base 150 of FIG. 13A. The adhesive film 98 can optionally be pushed down into the recess 154. For instance, the adhesive film 98 can be pushed down into the recess 154 such that the lateral regions of the adhesive film labeled L in FIG. 13B are adjacent to and can be in contact with the lateral sides of the recess. Additionally, the face region of the adhesive film labeled f in FIG. 13B are adjacent to and can be in contact with the face side of the recess. The flaps 122 of the adhesive film 98 can extend above the recess 154.

All or a portion of the lateral regions of the adhesive film labeled L in FIG. 13B and/or the face region of the adhesive film labeled f in FIG. 13B can optionally include a second adhesive that immobilizes the lateral regions of the adhesive film and/or the face region of the adhesive film relative to the case. As a result, the second adhesive can be the same or different from the adhesive on the flaps 122.

The electrode stack can be inserted into the recess on top of the adhesive film 98 as shown in FIG. 13D. The flaps 122 can be adhered to the face 102 of the electrode stack to provide an electrical assembly as shown in FIG. 13D. The dashed lines in FIG. 13D illustrate the location of flaps 122 under other flaps 122. As with the electrical assemblies disclosed above, the exposed region 112 of the substrate 110 is positioned over the edges 100 of the electrode stack and the flaps 122 are positioned over and adhered to the faces 102 of the electrode stack. When an adhesive is positioned on the substrate within the dashed line labeled A in FIG. 13B, all or a portion of the region within the dashed line labeled A in FIG. 13B can be adhered to a face 102 on the underside of the electrode stack.

The cover 152 can be attached to the base 150 to provide the capacitor of FIG. 13E. Suitable approaches for joining the base 150 and the cover include, but are not limited to, welding.

FIG. 13D illustrates the electrical conductor 94 passing from the electrode assembly 22 over an edge of the base 150. The electrical conductor 94 can pass through a lateral side of the base 150 or the cover 152 or can pass between the base 150 and cover 152. The interface between the case and the electrical conductor 94 can be constructed so the electrical conductor 94 is not in electrical communication with the case. For instance, the electrical conductor 94 can pass through an electrically insulating ferrule, grommet, frit, or tube that is positioned case so as to insulate the electrical conductor 94 from the case. Suitable electrically insulating materials include, but are not limited to, rubbers including synthetic rubbers such as Ethylene Propylene Diene Monomer rubber (EPDM rubber).

In the configuration of FIG. 13A through FIG. 13E, the terminal 90 do not remain exposed. However, electrical contact between the face of the electrode stack on the bottom of the electrode stack and the case can be made through the opening 138 in the adhesive film shown in FIG. 13C. Additionally, electrical contact between the face 102 of the electrode stack shown in FIG. 13D and the cover 152 of the case can be made. As a result, the case can act as one of the terminals for the capacitor and the electrical conductor 94 can act as another terminal for the capacitor. In particular, the case can act as the cathode terminals for the capacitor.

Although the method of FIG. 13A through FIG. 13E is illustrated using the base 150 to receive the electrode stack, the same method can be performed using a cover 152 having a recess that receives the adhesive film and the electrode stack.

The case disclosed in the context of FIG. 13A through FIG. 13E can be used with other electrode assemblies. For instance, the above electrode assemblies that are constructed outside of the case can be inserted into case with contact between one or more terminals 90 and/or electrical communication between one or both faces of the electrode stack and the case.

The above electrode assemblies can include one or more adhesive films that cover more than 50%, or 90% of the one or more edges of the electrode assembly.

In some instances, the flaps one or both faces of the above electrode assemblies are not positioned, or are not substantially positioned, over the one or more edges of the electrode assembly. Additionally or alternately, in some instances, each of the one or more covered regions of an adhesive film are not positioned over the one or more edges of the electrode assembly and/or each of the one or more edge regions of an adhesive film are not positioned over a face of the electrode assembly. However, the above electrode assemblies are subject to normal levels of error and tolerance during the fabrication of the electrode assembly. As a result, in some instances, all or a portion of the flaps one or both faces of the above electrode may be positioned over the one or more edges of the electrode assembly; all or a portion of the one or more covered regions of an adhesive film may by positioned over the one or more edges of the electrode assembly and/or all or a portion of the one or more edge regions on an adhesive film are not positioned over a face of the electrode assembly.

In the above descriptions of the electrode assembly, different features of adhesive films are described as being positioned over and/or covering one or more features of an electrode stack. A feature of an adhesive film being over or covering a feature of an electrode stack can be determined in a direction that is perpendicular to the portion of the electrode stack underlying the adhesive film feature.

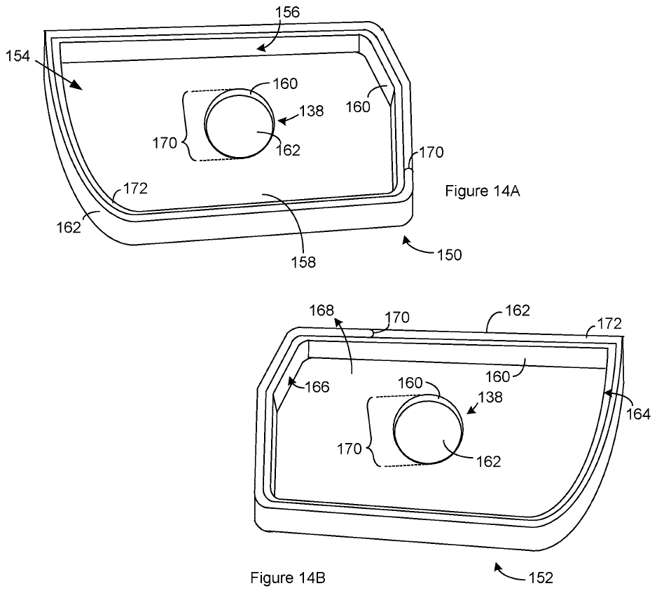

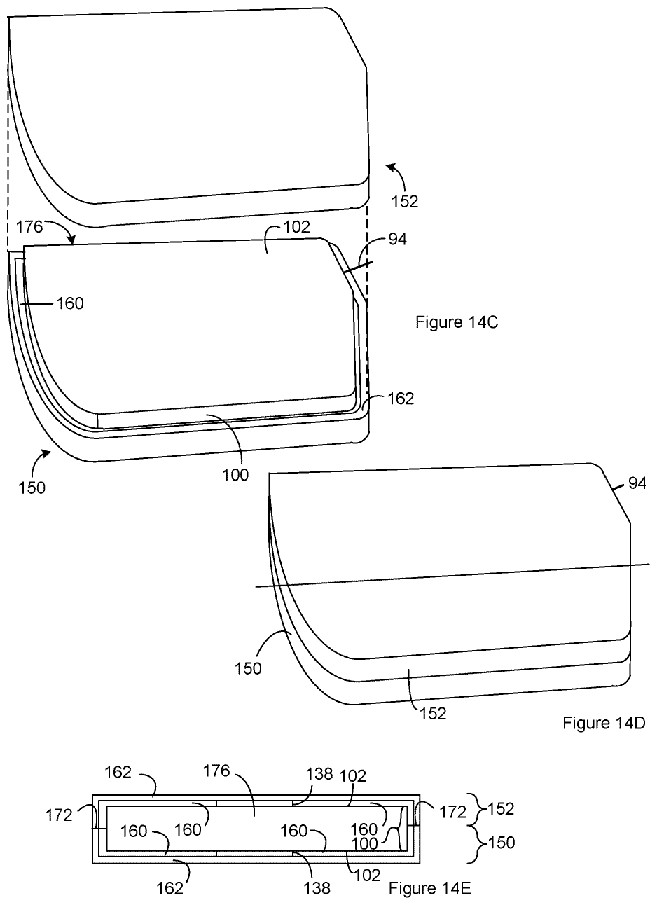

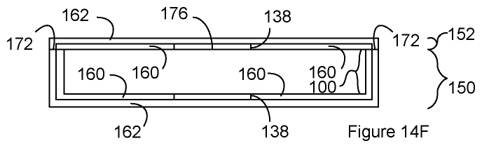

The base 150 and cover 152 of the case disclosed in the context of FIG. 13A through FIG. 13E can be constructed of a single layer of an electrically conducting material. However, the base 150 and cover 152 of the case can be constructed with multiple different layers. For instance, FIG. 14A is a perspective view of the base 150 constructed with a layer of an electrical insulator 160 on a layer of an electrically conducting material 162. FIG. 14B is a perspective view of the cover 152 constructed with a layer of the electrical insulator 160 on a layer of an electrically conducting material 162. Suitable electrically conducting materials 162 include, but are not limited to, metals such as stainless and aluminum. Suitable electrical insulators 160 include, but are not limited to, fluoropolymer, silicones, parylene, Endura.

The base 150 and cover 152 can be joined together so as to form the case for the capacitor. A recess can extend into the base 150 and/or the cover 152 so as to define an interior volume within the case. FIG. 14A illustrates a recess 154 extending into the base 150. The recess 154 has lateral sides 156 and a face side 158. FIG. 14B illustrates an optional recess 164 extending into the cover 152. The recess 164 has lateral sides 166 and a face side 168. An interior volume can be defined within the case by the interior of the recess 154 in the base 150 and the interior of the recess 164 in the cover 152. The interior volume is sized to receive an electrode stack when the base 150 is attached to the cover 152.

The electrically conducting material 162 in the base 150 and in the cover 152 includes one or more exposed regions 170 where the electrical insulator 160 is not positioned on the electrically conducting material 162. For instance, an edge 172 of the electrically conducting material 162 in the base 150 and in the cover 152 can be an exposed region 170. Additionally, an opening 138 through the electrical insulator 160 in the base 150 and/or in the cover 152 can expose a face of the electrically conducting material 162.

An electrode stack 176 can be received in the recess 154 as shown in FIG. 14C. The electrical insulator 160 surrounds the electrode stack. For instance, the electrical insulator 160 surrounds the one or more edges 100 of the electrode stack. The cover 152 can be attached to the base 150 to provide the capacitor of FIG. 14D and FIG. 14E. FIG. 14E is a cross section of the capacitor shown in FIG. 14D taken along the line labeled E in FIG. 14D. The edge 172 of the electrically conducting material 162 in the base 150 can contact the edge 172 of the electrically conducting material 162 in the cover 152 to simplify attachment processes such as welding.

The electrical insulator 160 in the base 150 can contact the electrical insulator 160 in the cover 152 at the interface between the base 150 and the cover 152 as is evident in 14E. The electrical insulator 160 over the lateral sides of the base 150 and the electrical insulator 160 over the lateral sides of the cover 152 is positioned over the one or more edges 100 of the electrode stack 176. As a result, the electrical insulator 160 from the base 150 and the cover 152 combine to electrically insulate the one or more edges 100 of the electrode stack 176 from the case. The electrical insulator 160 on the face side 158 of the base 150 is over a first face 102 of the electrode stack and the electrical insulator 160 on the face side 168 of the cover 152 is over a second face 102 of the electrode stack.

FIG. 14C illustrates the electrical conductor 94 passing from the electrode stack 176 over the edge 172 of the electrically conducting material 162 in the base 150. The electrical conductor 94 can pass through a lateral side of the base 150 or the cover 152 or can pass between the base 150 and cover 152. The interface between the case and the electrical conductor 94 can be constructed so the electrical conductor 94 is not in electrical communication with the case. For instance, the electrical conductor 94 can pass through an electrically insulating ferrule, grommet, frit, or tube that is positioned so as to insulate the electrical conductor 94 from the case. Suitable electrically insulating materials include, but are not limited to, rubbers including synthetic rubbers such as Ethylene Propylene Diene Monomer rubber (EPDM rubber).

In the configuration of FIG. 14A through FIG. 14E, the terminals 90 on the electrode stack 176 do not remain exposed. However, electrical contact between the face of the electrode stack 176 on the bottom of the electrode stack and the case can be made through the opening 138 in the electrical insulator 160. Additionally, electrical contact between the face 102 of the electrode stack 176 shown in FIG. 14C and the case can be made through the opening 138 in the electrical insulator 160 on the cover 152. As a result, the case can act as one of the terminals for the capacitor and the electrical conductor 94 can act as another terminal for the capacitor. In particular, the case can act as the cathode terminals for the capacitor.

FIG. 14F illustrates the cross section of FIG. 14E when the cover 152 excludes a recess 164. The electrical insulator 160 on the lateral sides of the base 150 is positioned over the edge 100 of the electrode stack. As a result, the electrical insulator 160 from the base 150 electrically insulates the one or more edges 100 of the electrode stack 176 from the case. The electrical insulator 160 on the face side of the base 150 is over a first face 102 of the electrode stack and the electrical insulator 160 on the cover 152 is over a second face 102 of the electrode stack.

The layer of electrical insulator 160 can be formed on the electrically conducting material 162 in the base 150 and/or in the cover 152 by techniques such as powder coating, vapor deposition such as Chemical Vapor Deposition (CVD), dipping, painting, spraying, electrostatic deposition, and fluidized bed deposition. Any desired exposed regions 170 can be formed by masking the electrically conducting material 162 where the exposed regions 170 is desired during the formation of the electrical insulator 160 on the electrically conducting material 162. The mask and any overlaying electrical insulator 160 can be removed after the formation of the electrical insulator 160 on the electrically conducting material 162. Alternately, the electrical insulator 160 can be removed from the electrically conducting material 162 so as to form the exposed regions 170. Suitable methods of removing the electrical insulator 160 from the electrically conducting material 162 include, but are not limited to, laser ablation.

Although the method of FIG. 14A through FIG. 14E is illustrated using the base 150 to receive the electrode stack, the same method can be performed using a cover 152 having a recess that receives the adhesive film and the electrode stack.

Although the adhesive film is disclosed in the context of an adhesive film where adhesive is not positioned on one face of a substrate, the adhesive can be positioned on both faces of the substrate as desired.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. An electrolytic capacitor, comprising:
a cathode that includes a porous material on a cathode metal, a face of the cathode metal including a shelf that is not under the porous material, the shelf extending out from under the porous material to an edge of the cathode metal;
an electrode stack having faces between one or more edges, a bent portion of the one or more edges having a bend in the one or more edges, wherein the cathode is included in the electrode stack; and
an adhesive film being positioned on the electrode stack such that the adhesive film is positioned over the bent portion of the one or more edges.

2. The electrolytic capacitor of claim 1, wherein the shelf surrounds a footprint of the porous material on the cathode metal.

3. The electrolytic capacitor of claim 1, wherein the cathode metal is titanium and the porous material is titanium nitride (TiN).

4. The electrolytic capacitor of claim 1, wherein an edge portion of the shelf has a length greater than 0.5 inch.

5. The electrolytic capacitor of claim 1, wherein a width of an edge portion of the shelf is less than 0.2 inches and a length of the edge portion of the shelf is greater than 0.5 inch.

6. The electrolytic capacitor of claim 1, wherein the shelf includes a tab portion connected to an edge portion of the shelf, a width of the tab portion of the shelf exceeding a width of the edge portion of the shelf.

7. The electrolytic capacitor of claim 1, wherein the shelf includes a tab portion connected to an edge portion of the shelf, and
the tab portion and the edge portion combine to surround a footprint of the porous material on the cathode metal.

8. The electrolytic capacitor of claim 1, wherein the shelf includes a tab portion, the tab portion being welded to a second tab, the second tab being included in a second cathode.

9. The electrolytic capacitor of claim 1, wherein
the adhesive film includes multiple flaps, the multiple flaps including a first flap connected to a first portion of an edge region of the adhesive film and a second flap connected to a second portion of the edge region of the adhesive film,
the first flap and the second flap being positioned over a first one of the faces of the electrode stack,
a lateral edge of the first flap intersecting a lateral edge of the second flap at a common location.

10-16. (canceled)

17. A capacitor, comprising
an electrode stack having faces between one or more edges, a bent portion of the one or more edges having a bend in the one or more edges; and
an adhesive film being positioned on the electrode stack such that an edge region of the adhesive film is positioned over the bent portion of the one or more edges.

18. The capacitor of claim 17, wherein the adhesive film includes multiple flaps, the multiple flaps including a first flap connected to a first portion of the edge region and a second flap connected to a second portion of the edge region, wherein the first flap and the second flap are adhered to a first face of the electrode stack.

19. The capacitor of claim 18, wherein the edge region of the adhesive film is not adhered to the bent portion of the one or more edges.

20. The capacitor of claim 18, wherein a portion of the first flap overlaps a portion of the second flap and the second flap is adhered to the first flap.

21. The capacitor of claim 18, wherein a lateral edge of the first flap intersects a lateral edge of the second flap at a common location, wherein the common location is over the bend in the electrode stack.

22. The capacitor of claim 18, wherein:
the bend in the one or more edges is a corner;
the one or more edges of the electrode stack is multiple edges,
a first one of the multiple edges meets a second one of the multiple edges at the corner; and
the first portion of the edge region is positioned over the first one of the edges and the second portion of the edge region is positioned over the second one of the multiple edges.

23. The capacitor of claim 18, wherein:
the bend in the one or more edges is a curve in the one or more edges; and
the first portion of the edge region is positioned over a first portion of the curve and the second portion of the edge region is positioned over a second portion of the curve.

24. The capacitor of claim 18, wherein the first flap and the second flap each excludes wrinkles or pleats.

25. The capacitor of claim 18, wherein the first flap includes an adhesive on a substrate and the second flap includes the adhesive on the substrate and any region of the first flap and the second flap that includes the adhesive on the substrate being bonded to one or more components selected from a group consisting of the first face of the electrode stack and one or more adhered flaps where each of the one or more adhered flaps is one of the multiple flaps other than the first flap.

26. The capacitor of claim 17, wherein the adhesive film is a piece of tape.

27. (canceled)

28. The capacitor of claim 21, wherein the lateral edge of the first flap and the lateral edge of the second flap extend in different directions from the one of the one or more edges of the electrode stack across the first face of the electrode stack.

29. (canceled)
